(19) United States
(12) Patent Application Publication
(10) Pub. No.: US 2003/0167460 A1
(43) Pub. Date: Sep. 4, 2003

(54) Processor instruction set simulation power estimation method

(76) Inventors: Vipul Anil Desai, Palatine, IL (US); David P. Gurney, Carpentersville, IL (US); Benson Chau, Mt. Prospect, IL (US); Kevin M. Cutts, Schaumburg, IL (US)

Correspondence Address: MOTOROLA, INC., 1303 EAST ALGONQUIN ROAD, IL01/3RD, SCHAUMBURG, IL, 60196

(21) Appl. No.: 10/082,900

(22) Filed: Feb. 26, 2002

(51) Int. Cl. G06F 9/45

(52) U.S. Cl. 717/151; 703/22; 717/154; 717/159

(57) ABSTRACT

A plurality of compound Single Instruction/Multiple Data instructions in the form of vector arithmetic unit instructions and vector network unit instructions are disclosed. Each compound Single Instruction/Multiple Data instruction is formed by a selection of two or more Single Instruction/Multiple Data operations of a reduced instruction set computing type, and a combination of the selected Single Instruction/Multiple Data operations to execute in a single instruction cycle to thereby yield the compound Single Instruction/Multiple Data instruction.

### FIELD OF THE INVENTION

In general, the present invention relates to the field of communication systems. More specifically, the present invention relates to vector and Single Instruction/Multiple Data (“SIMD”) processor instruction sets dedicated to facilitate a required throughput of communication algorithms.

### BACKGROUND OF THE INVENTION

Digital signal processor (“DSP”) algorithms are rapidly becoming more and more complex, often requiring thousands of MOPS (millions of operations per second) of processing for third generation (3G) and fourth generation (4G) communications systems (e.g., in interference cancellation, multi-user detection, and adaptive antenna algorithms). State of the art DSPs consume on the order of 1 mW/MOP, which could potentially result in several watts of DSP power consumption at these processing levels, making the current consumption of such devices prohibitive for portable (e.g., battery powered) applications. A combination of high processing throughput and low power consumption is needed for portable devices.

Vector or SIMD processors provide an excellent means of implementing high throughput signal processing algorithms. However, typical vector or SIMD processors also have high power consumption, limiting their use in portable electronics. There are many degrees of freedom when coding a signal processing algorithm on a vector or SIMD processor (i.e., there are many different ways to code the same algorithm), since there is a wide variety of high and low level paradigms that can be applied to solve a processing problem. A wide variety of instructions exist on any given vector processor which can be used to implement a given algorithm and perform the same functions. Different instructions can have drastically different operating characteristics on vector or SIMD processors. Though these implementations may provide the same processing output, they will have differences in other key characteristics, namely power consumption. It is very important for a system or software designer to fully understand these trade-offs that are made during the design cycle.

An instruction set simulator (“ISS)” is a commonly-used tool for developing microprocessor algorithms. During the development of a microprocessor algorithm, an ISS can be used to provide cycle accurate simulations of a proposed algorithm design. It also allows a developer to ‘run’ code before a design has been committed to silicon. Using information gleaned from this work, changes can be made in the development of the signal processing algorithm, or even the processor design, in a very early stage of development. More importantly, high-level changes to the software architecture (i.e., DSP algorithm structure) can easily be made to exploit key processor characteristics. Unfortunately, ISSs traditionally only allow one to understand the functional nature of the algorithm design. Power estimation tools are also available, but typically focus on the chip silicon design itself, and not the effect that typical software will have on the overall design. DSP power consumption is vital to good system design, yet the impact of the software algorithm itself is not traditionally considered. DSP algorithm impact on power performance will become more and more critical as communications systems increase in complexity, as is seen in 3G and 4G systems.

The present invention therefore addresses a need for accessing and incorporating DSP algorithms impacts in the power performance of a communication system.

### SUMMARY OF THE INVENTION

The invention provides power efficient vector instructions, and allows critical power trade-offs to readily be made early in the algorithm code development process for a given DSP architecture to thereby improve the power performance of the architecture. More particularly, the invention couples energy efficient compound instructions with a cycle accurate instruction set simulator with power estimation techniques for the proposed processor.

One form of the present invention is a method comprising a selection of at least two Single Instruction/Multiple Data operations of a reduced instruction set computing type, and a combining of the two or more Single Instruction/Multiple Data operations to execute in a single instruction cycle to thereby yield the compound Single Instruction/Multiple Data instruction.

A second form of the present invention is a method comprising a determination of a plurality of relative power estimates of a design of a microprocessor, and a determination of an absolute power estimate of a software algorithm to be executed by the processor based on the relative power estimates.

A third form of the present invention is a method comprising an establishment of a relative energy database file listing a plurality of micro-operations with each micro-operation having an associated relative energy value, and a determination of an absolute power estimate of a software algorithm incorporating one or more of the micro-operations based on the relative energy values of the incorporated micro-operations.

A fourth form of the invention is a method comprising a determination of a plurality of relative power estimates of a design of a microprocessor, a development of a software algorithm including one or more compound instructions, and a determination of an absolute power estimate of a software algorithm to be executed by the microprocessor based on the relative power estimates.

The foregoing forms as well as other forms, features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 illustrates a flowchart representative of one embodiment of a compound Single Instruction/Multiple Data instruction formation method in accordance with the present invention;

FIG. 2 illustrates a flowchart representative of one embodiment of a Single Instruction/Multiple Data instruction operation selection method in accordance with the present invention;

FIG. 3 illustrates a flowchart representative of one embodiment of a power consumption method in accordance with the present invention;

FIG. 4 illustrates an operation of a first embodiment of a vector arithmetic unit instruction in accordance with the present invention;

FIG. 5 illustrates an operation of a second embodiment of a vector arithmetic unit instruction in accordance with the present invention;

FIG. 6 illustrates an operation of a third embodiment of a vector arithmetic unit instruction in accordance with the present invention;

FIG. 7 illustrates an operation of a fourth embodiment of a vector arithmetic unit instruction in accordance with the present invention;

FIG. 8 illustrates an operation of a fifth embodiment of a vector arithmetic unit instruction in accordance with the present invention;

FIG. 9 illustrates an operation of a sixth embodiment of a vector arithmetic unit instruction in accordance with the present invention;

FIG. 10 illustrates an operation of a seventh embodiment of a vector arithmetic unit instruction in accordance with the present invention;

FIG. 11 illustrates an operation of an eighth embodiment of a vector arithmetic unit instruction in accordance with the present invention;

FIG. 12 illustrates an operation of a ninth embodiment of a vector arithmetic unit instruction in accordance with the present invention;

FIG. 13 illustrates an operation of a tenth embodiment of a vector arithmetic unit instruction in accordance with the present invention;

FIG. 14 illustrates an operation of an eleventh embodiment of a vector arithmetic unit instruction in accordance with the present invention;

FIG. 15 illustrates an operation of a twelfth embodiment of a vector arithmetic unit instruction in accordance with the present invention;

FIG. 16 illustrates an operation of a thirteenth embodiment of a vector arithmetic unit instruction in accordance with the present invention;

FIG. 17 illustrates an operation of a fourteenth embodiment of a vector arithmetic unit instruction in accordance with the present invention;

FIG. 18 illustrates an operation of a fifteenth embodiment of a vector arithmetic unit instruction in accordance with the present invention;

FIG. 19 illustrates an operation of a first embodiment of a vector network unit instruction in accordance with the present invention;

FIG. 20 illustrates an operation of a second embodiment of a vector network unit instruction in accordance with the present invention;

FIG. 21 illustrates an operation of a third embodiment of a vector network unit instruction in accordance with the present invention;

FIG. 22 illustrates an operation of a fourth embodiment of a vector network unit instruction in accordance with the present invention;

FIG. 23 illustrates an operation of a fifth embodiment of a vector network unit instruction in accordance with the present invention;

FIG. 24 illustrates an operation of a sixth embodiment of a vector network unit instruction in accordance with the present invention;

FIG. 25 illustrates an operation of a seventh embodiment of a vector network unit instruction in accordance with the present invention;

FIG. 26 illustrates an operation of an eighth embodiment of a vector network unit instruction in accordance with the present invention;

FIG. 27 illustrates an operation of a ninth embodiment of a vector network unit instruction in accordance with the present invention;

FIG. 28 illustrates an operation of a tenth embodiment of a vector network unit instruction in accordance with the present invention;

FIG. 29 illustrates an operation of an eleventh embodiment of a vector network unit instruction in accordance with the present invention;

FIG. 30 illustrates an operation of a twelfth embodiment of a vector network unit instruction in accordance with the present invention;

FIG. 31 illustrates an operation of a thirteenth embodiment of a vector network unit instruction in accordance with the present invention;

FIG. 32 illustrates an operation of a fourteenth embodiment of a vector network unit instruction in accordance with the present invention;

FIG. 33 illustrates a flowchart representative of a power consumption estimation method in accordance with the present invention;

FIG. 34 illustrates a flowchart representative of one embodiment of a relative power consumption method in accordance with the present invention; and

FIG. 35 illustrates a flowchart representative of one embodiment of an absolute power consumption method in accordance with the present invention.

### DETAILED DESCRIPTION OF THE PRESENTLY PREFERRED EMBODIMENTS

Vector or Single Instruction/Multiple Data (“SIMD”) processors perform several operations/computations per instruction cycle. The term “processor” is a generic term that can include architectures such as a micro-processor, a digital signal processor, and a co-processor. An instruction cycle generally refers to the complete execution of one instruction, which can consist of one or more processor clock cycles. In the preferred embodiment of the invention, all instructions are executed in a single clock cycle, thereby increasing overall processing throughput. Note that other embodiments of the invention may employ pipelining of instruction cycles in order to increase clock rates, without departing from the spirit of the invention. These computations occur in parallel (e.g., in the same instruction or clock cycle) on data vectors that consist of several data elements each. In SIMD processors, the same operation is typically performed on each of the data elements per instruction cycle. A data element may also be called a field. Vector or SIMD processors traditionally utilize instructions that perform simple reduced instruction set computing (RISC)-like operations. Some examples of such operations are vector addition, vector subtraction, vector comparison, vector multiplication, vector maximum, vector minimum, vector concatenation, vector shifting, etc. Such operations typically access one or more data vectors from the register file and produce one result vector, which contains the results of the RISC-like operation.

Signal processing algorithms are typically made up of a sequence of simple operations that are repeatedly performed to obtain the desired results. Some examples of common communications signal processing algorithms are fast Fourier transforms (FFTs), fast Hadamard transforms (FHTs), finite impulse response (FIR) filtering, infinite impulse response (IIR) filtering, convolutional decoding (i.e, Viterbi decoding), despreading (e.g., correlation) operations, and matrix arithmetic. These algorithms consist of repeated sequences of simple operations. The present invention provides combinations of RISC-like vector operations in a single instruction cycle in order to increase processing throughput, and simultaneously reduce power consumption, as will be further described below. A class of increased throughput and reduced power consumption compound instructions can be developed, based on the frequency of occurrence, by grouping RISC-like vector or SIMD operations. The choice of such operations depends on the general type or class of signal processing algorithms to be implemented, and the desired increase in processing throughput for the chosen architecture. The choice may also depend on the level of power consumption savings that is desired, since compound operations can be shown to have reduced power consumption levels.

Any processor architecture has an overhead associated with performing the required computations. This overhead is incurred on every instruction cycle of a piece of executed software code. This overhead takes the form of instruction fetching, instruction decoding/dispatch, data fetching, data routing, and data write-back. A complete instruction cycle can be viewed as a sequence of micro-operations, which contains the overhead of the above operations. Generally, overhead is considered any operation that does not directly result in useful computation (that is required from the algorithm point of view). All of these forms of overhead result in wasted power consumption during each instruction cycle from the required computation point of view (i.e., they are required due to the processor implementation, and not the algorithm itself. Therefore, any means that reduces this form of overhead is desirable from an energy efficiency point of view. The overhead may also limit processing throughput. Again any means that reduces the overhead can also improve throughput.

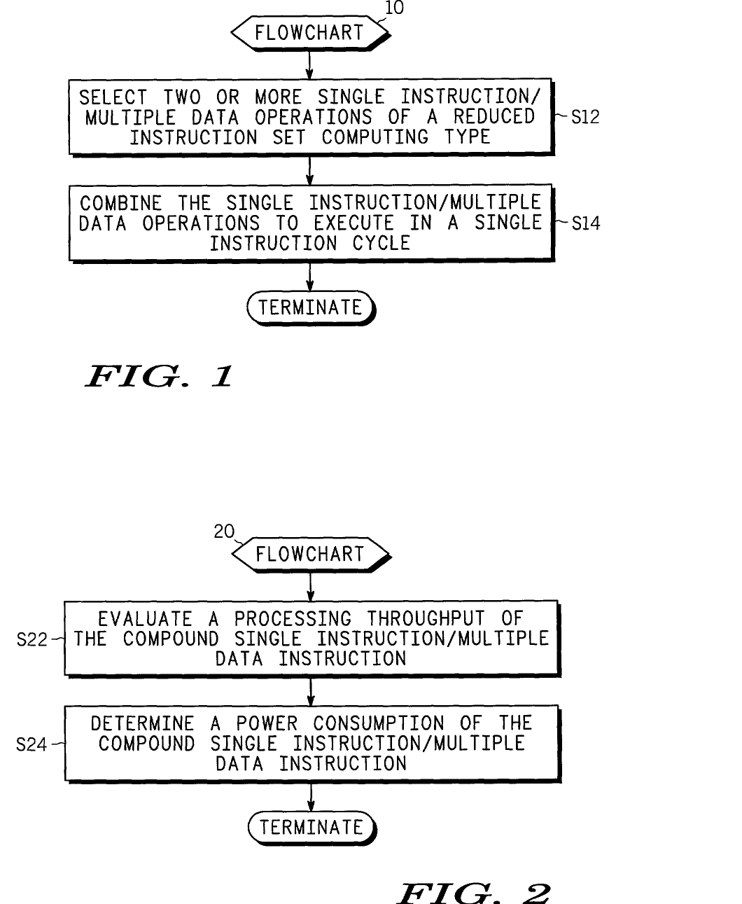

FIG. 1 illustrates a flowchart 10 representative of a Single Instruction/Multiple Data instruction formation method of the present invention. An implementation of the flowchart 10 provides compound vector or SIMD operations and conditional operations on an element by element basis for compound vector or SIMD instructions in order to increase processing efficiency (e.g., throughput and current drain). These compound vector or SIMD instructions may consist of a combination of the RISC-like vector operations described above, and conditional operations on a per-data element basis. These compound vector or SIMD instructions can be shown to greatly improve processing speed (e.g., processing throughput) and reduce the energy consumption for a variety of signal processing algorithms. A compound vector or SIMD instruction may consist of two or more RISC-like vector operations, and is limited in practice only by the additional hardware complexity (e.g., hardware arithmetic logic units (ALUs) and register file complexity) that is acceptable for the given processor.

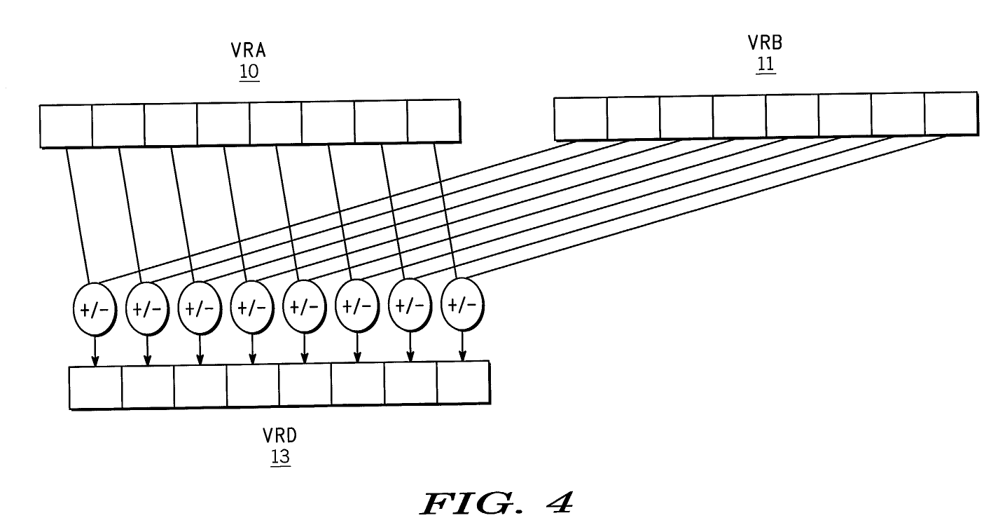

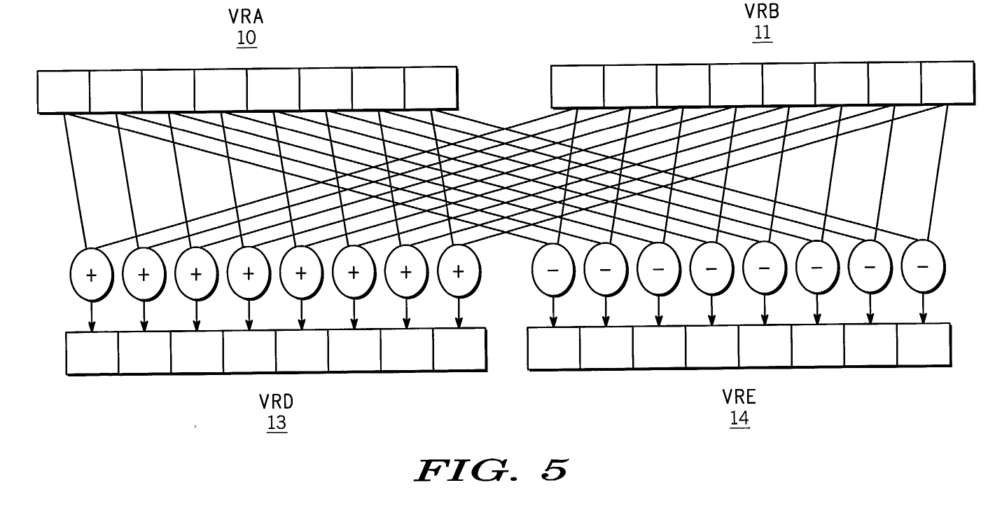

During a stage S12 of the flowchart 10, two or more RISC-like vector operations are selected, and during a stage S14 of the flowchart 10, the selected RISC-like vector operations are combined to form a compound SIMD instruction. In the process of selecting the RISC-like vector operations, an evaluation of potential processing throughput gains of the compound SIMD instruction is determined during a stage S22 of a flowchart 20 as illustrated in FIG. 2. This evaluation may involve a cycle-accurate instruction set simulator (ISS) executing a software algorithm. Typically, the processing throughput for a set of instructions, both RISC-type and compound, is determined by the number of clock cycles an algorithm requires, or its execution time. For example, the fewer the clock cycles an algorithm requires, the higher the throughput. For instance, FFT algorithms, especially radix-4 algorithms, are dominated by a large number of addition and subtraction operations. A vector add-subtract compound instruction, as shown in FIG. 5, has a higher throughput than separately performing vector addition and vector subtraction RISC-type instructions (both shown in FIG. 4) for FFT algorithms because two simultaneous operations (addition and subtraction) are executed in a single instruction cycle. The compound instruction also results in lower power consumption for the algorithm, as described below.

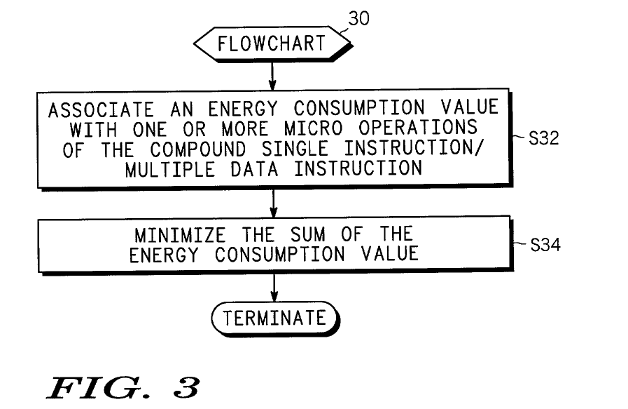

A stage S24 of the flowchart 20 involves a determination of the power consumption of the combined operations. In this stage, the micro-operations of the compound instruction are determined. Even a RISC-type vector operation contains several micro-operations. A compound SIMD may have a different number of micro-operations than the combination of RISC-type vector operations. In the process of determining the micro-operations, the energy consumption of each micro-operation is generated during a stage S32 of a flowchart 30 as illustrated in FIG. 3. Examples of determining the energy consumption of a micro-operation are described later. Thus, a database of micro-operations and the associated energy consumption value can be created. Exemplary TABLE 1, described later, shows a database of micro-operations and energy consumption values. The power consumption can be determined by summing all the energy consumption values from the micro-operations and multiplying by the frequency of the execution of the instruction per unit time (related to the throughput). During a stage S34 of the flowchart 30, the process of selecting operations are directed to a minimization of the sum of energy consumption of the micro-operations used in the compound instruction. This minimization of energy, in turn, may lower the power consumption of the instruction and algorithm. For example, the vector add-subtract compound instruction may have higher total energy consumption than a vector addition instruction has. But when the combined energy consumption of the vector addition and vector subtraction instructions is considered, that energy consumption may be higher than the compound instruction. Furthermore, when the processing throughput is considered, the compound instruction has a lower power consumption (due to less energy consumption and higher throughput) than the separate vector addition and vector subtraction instructions.

There may be other criteria for selecting SIMD operations to form a compound SIMD instruction. These criteria can include gate count, circuit complexity, speed limitations and requirements. It is straightforward to develop design rules for this selection.

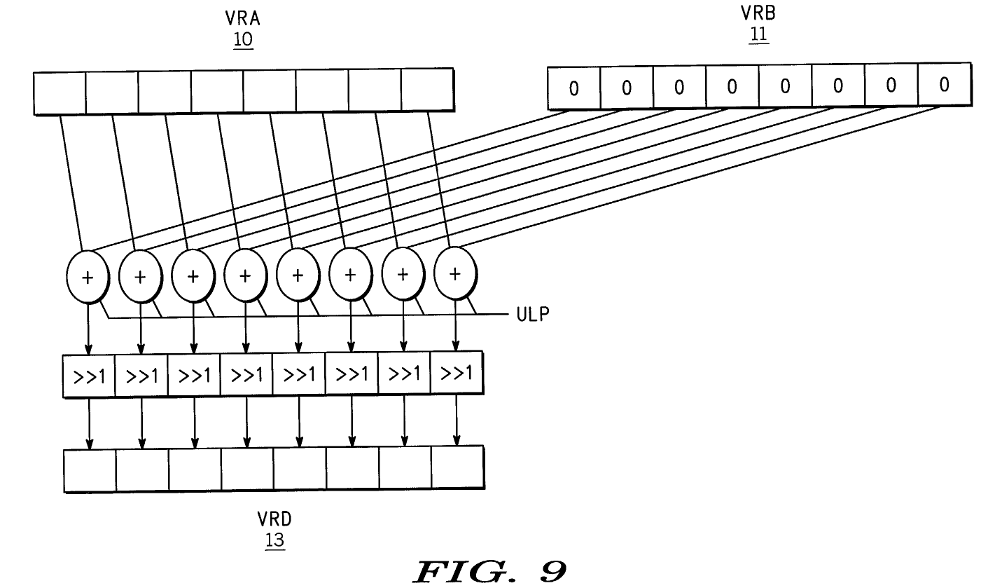

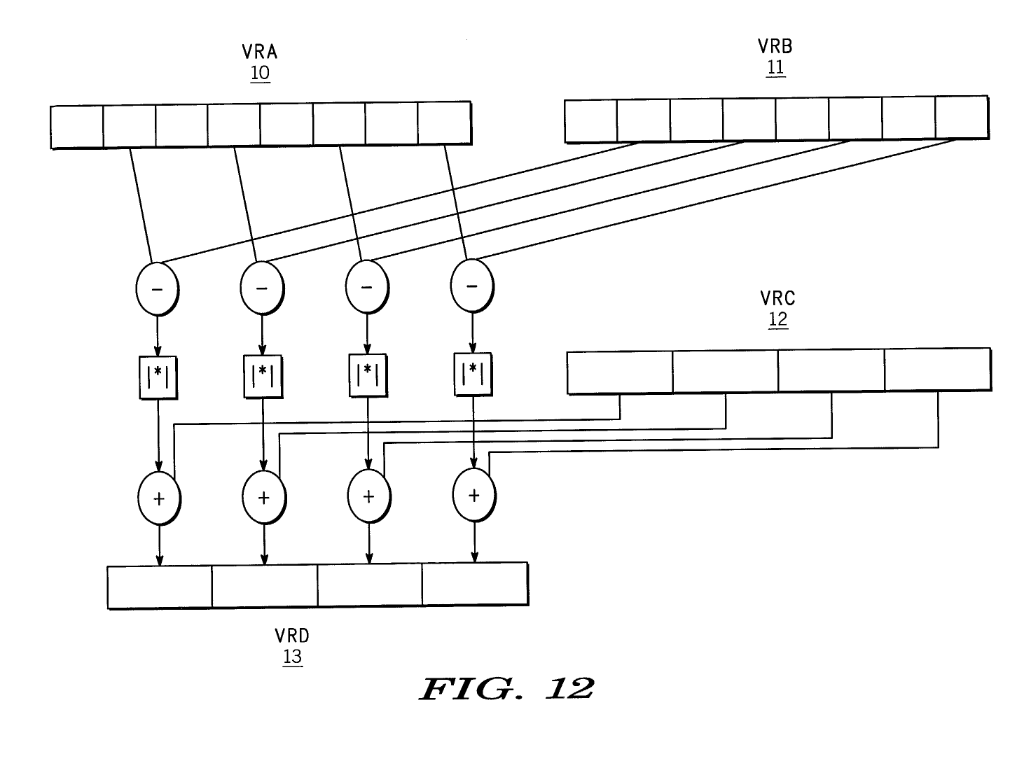

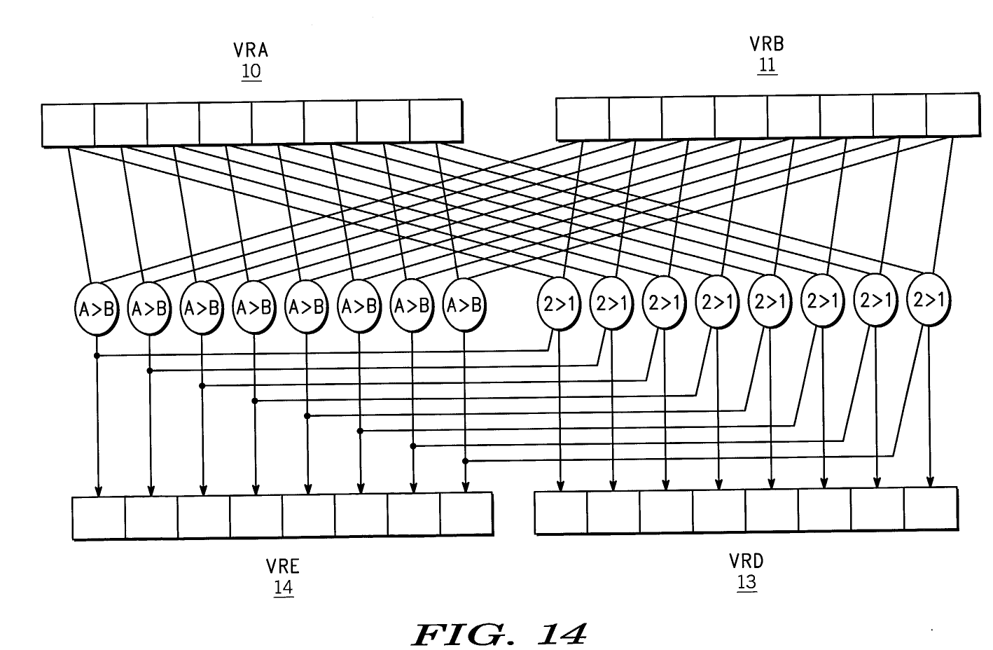

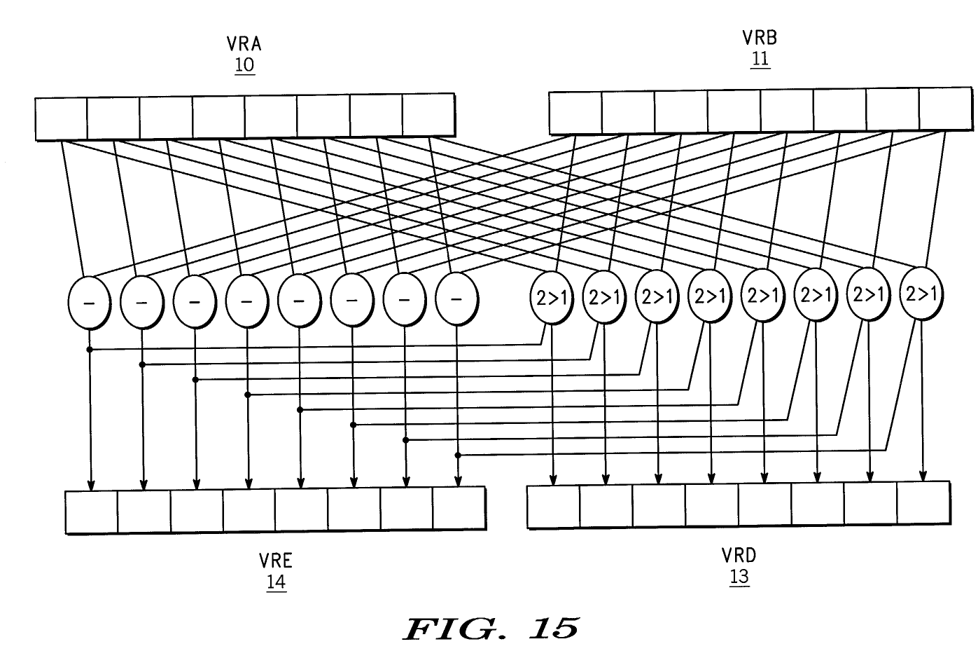

Some examples of such compound vector or SIMD instructions include vector add-subtract instruction, which simultaneously computes the addition and subtraction of two data vectors on a per-element basis, as shown in FIG. 5. Note once again that the terms vector and SIMD are used interchangeably in the description of the invention, with no loss of generality. Other examples include a vector absolute difference and add instruction, which computes the absolute value of the difference of two data vectors on a per-element basis, and sums the absolute difference with a third vector on a per element basis, as shown in FIG. 12. One other example includes a vector compare-maximum instruction, which simultaneously computes the maximum of a pair of data vectors on a per-element basis, and also sets a second result vector to indicate which element was the maximum of the two input vectors, as shown in FIG. 14. Another example includes a vector minimum-difference instruction, which simultaneously selects the minimum value of each data vector element pair, and produces the difference of the element pairs as shown in FIG. 15. Note that the hardware impact of such operations is minimal, since a difference value is typically calculated for each element pair to determine the minimum value. Yet another example includes a vector scale operation, which adds 1 (least significant bit “LSB”) to each data vector element and shifts each element to the right by one bit position, as shown in FIG. 9 (effectively implementing a divide by two with rounding). All of these compound vector or SIMD instructions are made up of two or more RISC-like vector operations, and increase the useful computation done per instruction cycle, thereby increasing the processing throughput. Further, compound SIMD instructions may be made up of other compound SIMD operations, such as for example, the vector add-subtract instruction includes a vector add-subtract operation. These compound vector or SIMD instructions also simultaneously lower the energy required to implement those computations, because they incur less of the traditional overhead (e.g., instruction fetching, decoding, register file reading and write-back) of vector processor designs, as further described below.

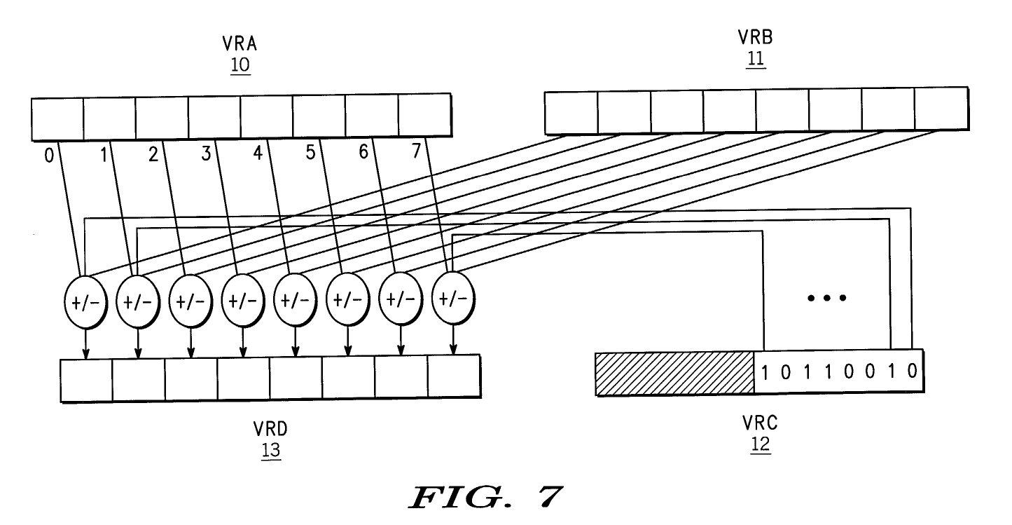

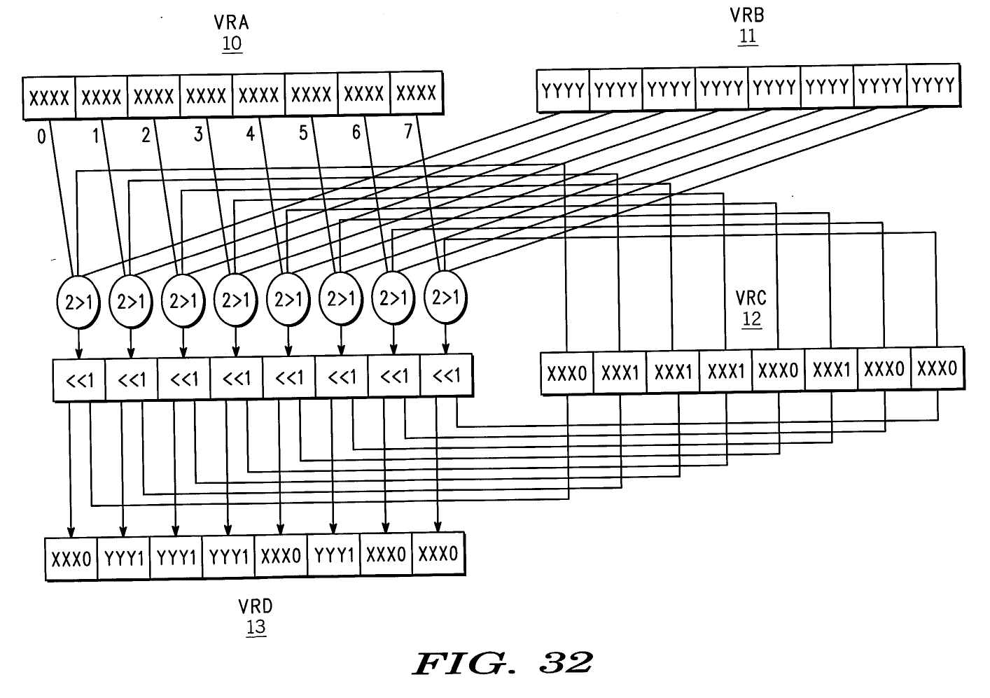

Another class of compound vector or SIMD instructions is formed from two or more RISC-like operations that have individual conditional control of the operation on each vector element (per instruction cycle). A useful example of such a conditional compound instruction is a vector conditional negate and add instruction, in which elements of one data vector are conditionally either added to or subtracted from the elements in another data vector, as shown in FIG. 7. Another example of a conditional compound instruction is the vector select and viterbi shift left instruction, which conditionally selects one of two elements from a pair of data vectors, appends a third conditional element, and shifts the resulting elements to the left by one bit position, as shown in FIG. 32. In general, one type of conditional operation on elements typically is in a form of a conditional transfer from one of two registers, which occurs, for example, in the vector select and Viterbi shift left instruction. Another type of conditional operation can be in a form of conditional execution, as in cases where an operation on an element is performed only if a specified condition is satisfied. Yet another type of conditional operation on elements involves the selection of an operation based on the condition, such as in the conditional add/subtraction operation as shown in FIG. 7. These compound conditional instructions offer significant opportunities to improve throughput (e.g., elimination of branches, pipeline stalls), and to lower power consumption. One skilled in the art can appreciate that there are many other combinations of compound vector instructions and conditional compound instructions that are not fully described here.

It can be shown that software code segments using compound SIMD instructions and conditional compound SIMD instructions require less energy to execute than code using traditional RISC-type instructions. This is due to many factors, but can be seen more clearly at the micro-operation level. Every instruction can be broken into micro-operations that make up the overall operation. Such micro-operations typically include an instruction memory fetch (access), instruction decode and dispatch (control), data operand fetch (memory or register file access), a sequence of RISC-like operations (that can be implemented in a single instruction cycle), and data result write-back (memory or register file access). It can be seen that compound instructions and conditional compound instructions require fewer micro-operations (e.g., fewer register file accesses, fewer instruction memory accesses, etc.), which results in lower power consumption. A method for definitively measuring and proving these results is presented below.

In a preferred embodiment, the instructions can be grouped by functional units within the processor. Some examples of functional units are vector arithmetic (VA) units to perform a variety of arithmetic processing, and vector network (VN) units to perform a variety of shifting/reordering operation. There may be other units such as load/store (LS) units to perform load (from memory) and store (to memory) operations, and branch control (BC) units to perform looping, branches, subroutines, returns, and jumps.

A detailed description of vector arithmetic unit instructions in accordance with the present invention is illustrated in FIGS. 4-18. The following convention is used in FIGS. 4-32. The processor in this embodiment comprises a register file with (vector) registers labeled VRA 10, VRB 11, VRC 12, VRD 13, and VRE 14. The labels VRx (where x=A,B,C,D,E) are generic register names. The processor may have more or fewer registers. In this embodiment, the register comprises m bits where m=128 bits; though different values of m may be used. An m-bit register may be partitioned into number of fields (NF) elements or fields of field size (FS) where FS=m/NF bits. Thus, a register represents a data vector having NF elements. In one example, a 128-bit register may be partitioned in 8 fields of size FS=16 bits. In this embodiment, the field size is a multiple of a byte (8-bits) and some nominal field size values are 8, 16, and 32. The field size is not required to be a multiple of a byte, in general. The bits in a field may be numbered starting (from right to left) from 0 (the LSB) to FS-1. Similarly, the bits in the register may be numbered from 0 to m−1. Even though the bit numbering can proceed from left to right, for simplicity of explanation, the numbering is from right to left. The term “x LSBs” may refer to bits x-1 through 0 for the register/field. Similarly, the term “x MSBs” may refer to the FS-1 through FS-x most significant bits (MSBs) of a field or to the m−1 through m-x MSBs of the register. The register may have fields with double field size (DFS). The relationship between field size and double field size is DFS=2×FS. For example, a 128-bit register may be partitioned into 4 fields of size DFS=32. The fields in the register may be numbered, for example, from 0 to NF-1. In this embodiment, the field 0 is the most significant field (on the left) while field NF-1 is the least significant field (on the right). Even though the field numbering can proceed from right to left, for simplicity of explanation, the numbering is from left to right. For explanation purposes, VRA 10, VRB 11, and VRC 12 are source registers while VRD 13 and VRE 14 are destination registers. To facilitate implementations of certain instructions, there may be a zero-valued register, where all the fields of the register have a value of zero. In this embodiment, the fields can represent signed integers, unsigned integers, and fractional values. The notions of fields can easily be extended to floating-point values.

In diagrams FIG. 4 to FIG. 32, the notation “>>i” refers to a right shift by i bits or octets/bytes, depending on the instruction. The right shift may be arithmetic or logical depending on the instruction. Similarly, the notation “<<i” refers to a left shift by i bits or octets/bytes. The left shift may be arithmetic or logical depending on the instruction. The notation “2>1” refers to a selection or multiplexing (muxing) operation which selects one field or the other field depending on an input signal. Some examples of the input signal sources are a result of a comparison operation, and a binary value. The notations “X” and “Y” refer to don't care values. This notation is introduced to explain the operation of an instruction. Similarly, hexadecimal numbering of fields may be introduced to explain the operation of an instruction. An intrafield operation is localized within a single field while an interfield operation can span one or more fields. An instruction with the mnemonic “x y/z” implies two instructions with the first instruction being “x y” while the second is “x z”. For example, the vector conditional negate and add/subtract compound instruction represents two instructions: a vector conditional negate and add compound instruction and a vector conditional negate and subtract compound instruction.

FIG. 4 illustrates an operational diagram of a Vector Add (“vadd”) and a Vector Subtract instruction of the present invention. This instruction performs a vector addition or a vector subtraction (depending on the instruction used) of each of the field size (FS)-bits fields of the register VRA 10 and the register VRB 11. The result is stored in the vector register VRD 13. The vector add and vector subtract instructions are both examples of RISC-type instructions that perform a SIMD operation of either addition or subtraction of fields.

FIG. 5 illustrates an operational diagram of a Vector Add-Subtract compound instruction of the present invention that performs both a vector addition and subtraction of each of the FS-bit fields of the register VRA 10 and the register VRB 11. The sum is stored in vector register VRD 13 while the difference is stored in vector register VRE 14. This compound instruction may be useful for convolutional decoding, complex Fast Fourier Transforms (FFTs), and Fast Hadamard Transforms (FHTs). The vector add-subtract instruction is a compound SIMD instruction that can be viewed as combining the RISC-type operations of vector addition and vector subtraction. Further, this compound SIMD instruction increases the processing throughput because two output vectors are simultaneously produced each instruction cycle. In this embodiment, the compound SIMD instruction can minimize the energy consumption of the addition and subtraction operations by reducing the number of micro-operations, such as register file reads. For example, a vector add instruction and a vector subtraction instruction would require a total of four register file reads while the compound SIMD instruction requires two register file reads.

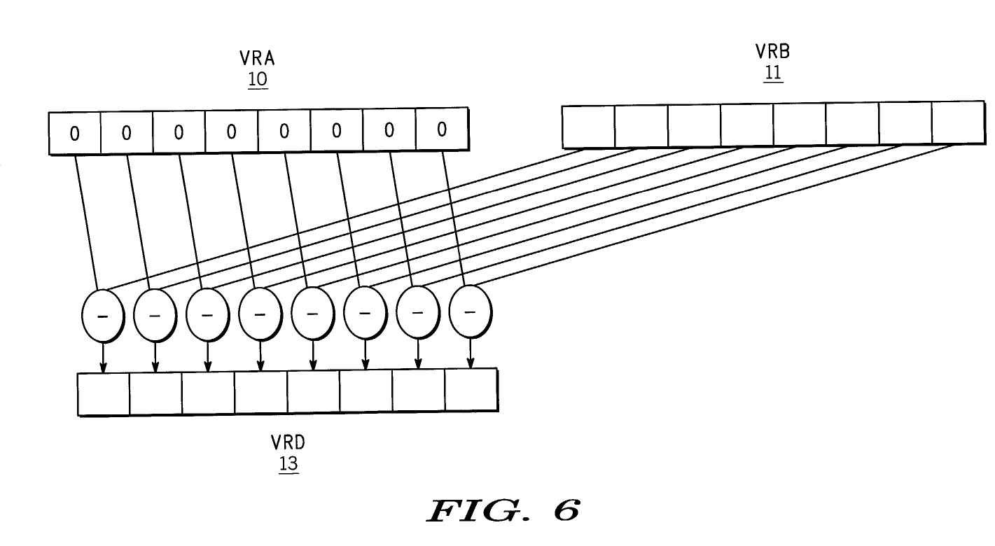

FIG. 6 illustrates an operational diagram of a Vector Negate instruction of the present invention. This compound instruction performs a negating operation (sign change) of each of the FS-bit fields of the register VRB 11 and places the result in the register VRD 13. This instruction may be implemented (i.e., aliased) using a vector subtract instruction with VRA 10 defined to be a zero-valued register. The vector negate instruction is an example of a RISC-type instruction.

FIG. 7 illustrates an operational diagram of a Vector Conditional Negate and Add/Subtract (‘vcnadd’/‘vcnsub’) compound instruction of the present invention that performs a vector addition or subtraction on the ith FS-bit field of register VRB 11 from the corresponding field of an input (accumulator) register VRA 10 depending on the state [conditional] of the ith bit of VRC 12—for example a binary one ‘1’ may denote subtraction while a binary zero ‘0’ may denote addition for the vcnadd instruction;—‘0’ may denote subtraction while ‘1’ may denote addition for the vcnsub instruction. The conditionals in register VRC 12 may be in a packed format (i.e., the NF LSBs of register VRC 12 are utilized). The register VRA 10 may also contain DFS-sized fields for full or extended precision arithmetic operations. The resulting accumulated values are stored in a vector register VRD 13. This compound instruction may be useful for complex CDMA (RAKE receiver) despreaders, convolutional decoders, and DFS accumulation. The vector conditional negate and add/subtract compound instruction is a compound SIMD instruction that can be viewed as combining the RISC-type operations of vector comparison (muxing), vector negation, and vector addition or vector subtraction. Further, this compound SIMD instruction increases the processing throughput because several sequential RISC steps are combined into one instruction cycle. In this embodiment, the compound SIMD instruction can significantly minimize the energy consumption, for example, by eliminating micro-operations due to branching (to perform the conditional operation). An example of this minimization is given in a code sequence below.

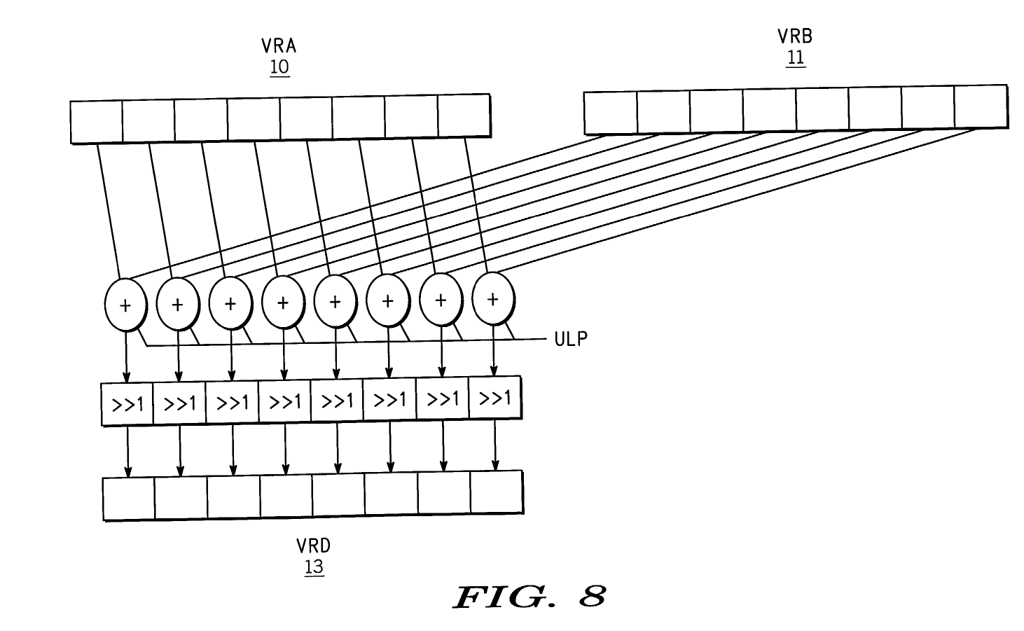

FIG. 8 illustrates an operational diagram of a Vector Average compound instruction of the present invention. This compound instruction performs a vector addition of fields from register VRA 10 and register VRB 11, adds ‘1’ LSB or unit in the least significant position (ULP) of each field, and then right shifts the result by one position (effectively adding the fields of two registers and dividing by two, with rounding), thereby producing the average of the two vectors. The vector average compound instruction is a compound SIMD instruction that can be viewed as combining the RISC-type operations of two vector additions, and vector arithmetic shifting. Further, this compound SIMD instruction increases the processing throughput because several sequential RISC steps are combined into one instruction cycle.

FIG. 9 illustrates an operational diagram of a Vector Scale compound instruction of the present invention that adds ‘1’ (ULP) to the fields of register VRA 10, and then right shifts (arithmetically) the result by one position (effectively scaling the input values by ½ with rounding). The vector scale instruction may be implemented (aliased) using the vector average instruction with VRB 11 defined to be a zero-valued register, as in this embodiment. This compound instruction may be useful for inter-stage scaling in FFTs/FHTs.

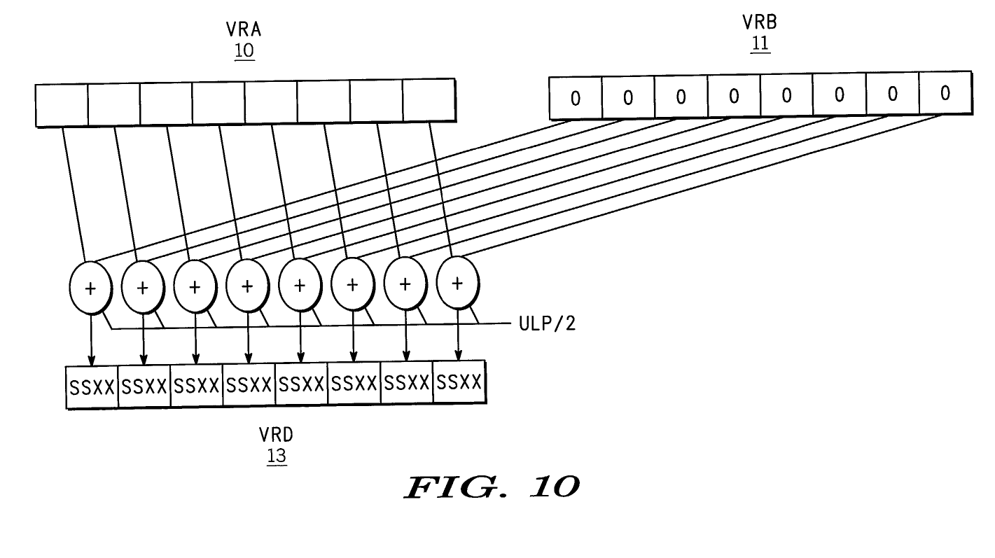

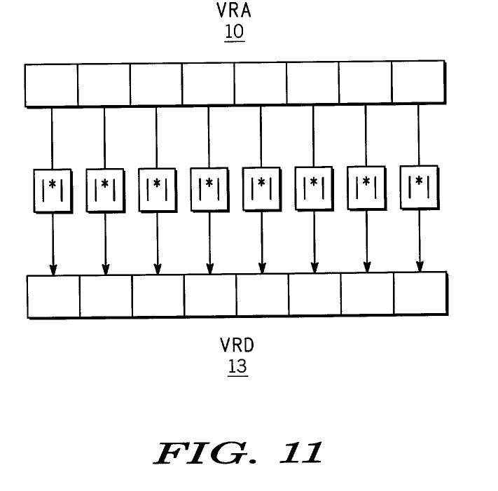

FIG. 10 illustrates an operational diagram of a Vector Round compound instruction of the present invention that is useful for reducing precisions of multiple results. This compound instruction rounds each FS-bit field of VRA 10 down to the specified field size (fs) by adding the appropriate constant (ULP/2). The results are saturated if necessary, and sign extended to the original field size, as denoted with the “SSXX” notation in the fields of VRD 13. The vector round compound instruction is a compound SIMD instruction that can be viewed as combining the RISC-type operations of vector addition, and vector arithmetic shifting. This instruction may be implemented by using a zero-valued register for VRB 11.

FIG. 11 illustrates an operational diagram of a Vector Absolute Value instruction of the present invention. This instruction performs an absolute value on the ith FS-bit field of the register VRA 10 and stores the results in register VRD 13.

FIG. 12 illustrates an operational diagram of a Vector Absolute Difference and Add compound instruction of the present invention that computes the absolute difference of the fields of registers VRA 10 and VRB 11, (i.e., |VRA 10-VRB 11|) and adds the double field size (DFS) result to the vector register VRC 12. Note that vector register VRC 12 and the vector register VRD 13 contain DFS-sized data elements to protect against overflow. In this embodiment, the odd-numbered fields of VRA 10 and VRB 11 are used. This compound instruction may be useful for various equalizers and estimators (e.g., timing/phase error accumulators). The vector absolute difference and add compound instruction is a compound SIMD instruction that can be viewed as combining the RISC-type operations of vector subtraction, vector absolute value, and vector addition, which once again results in fewer micro-operations (e.g., instruction fetches, decodes, and data accesses) and higher processing throughput.

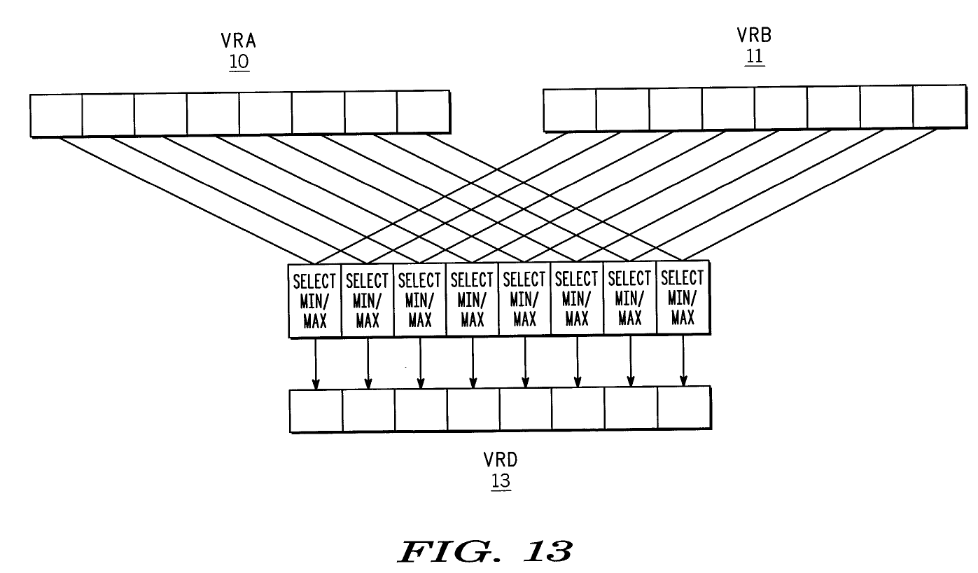

FIG. 13 illustrates an operational diagram of a Vector Maximum or Vector Minimum instruction of the present invention that stores the maximum or minimum value from the corresponding field pairs in register VRA 10 and register VRB 11 into register VRD 13. This simple RISC-type instruction may be useful for general peak data searches.

FIG. 14 illustrates an operational diagram of a Vector Compare-Maximum/Minimum compound instruction of the present invention that stores the maximum or minimum value of the corresponding field pairs from register VRA 10 and register VRB 11 in register VRD 13, and also stores the decision value (‘00 . . . ’=from VRA 10, ‘11 . . . ’=from VRB 11) in the corresponding fields of register VRE 14. This compound instruction may be useful for MLSE equalizers and Viterbi decoding. The notation “A>B” in FIG. 11 refers to a comparison operation. Note that decision values typically fill an entire data element of a vector, such that a true comparison result returns a binary ‘1111’ value in 4-bit data elements, and a false comparison returns a binary ‘0000’ value in the same data elements. The vector compare-maximum/minimum compound instruction is a compound SIMD instruction that can be viewed as combining a RISC-type SIMD operation (e.g., vector maximum or minimum) and the RISC-type comparison operation of muxing.

FIG. 15 illustrates an operational diagram of a Vector Maximum/Minimum-Difference compound instruction of the present invention that stores the maximum or minimum value of the corresponding field pairs from register VRA 10 and register VRB 11 in register VRD 13, and also stores the difference between each field of register VRB 11 and register VRA 10 in the corresponding fields of register VRE 14. This compound instruction may be useful for log-MAP Turbo decoding. The vector maximum/minimum-difference compound instruction is a compound SIMD instruction that can be viewed as combining a RISC-type SIMD operation (e.g., vector maximum or minimum) and the RISC-type operation of subtraction, which results in fewer overall micro-operations and higher throughput.

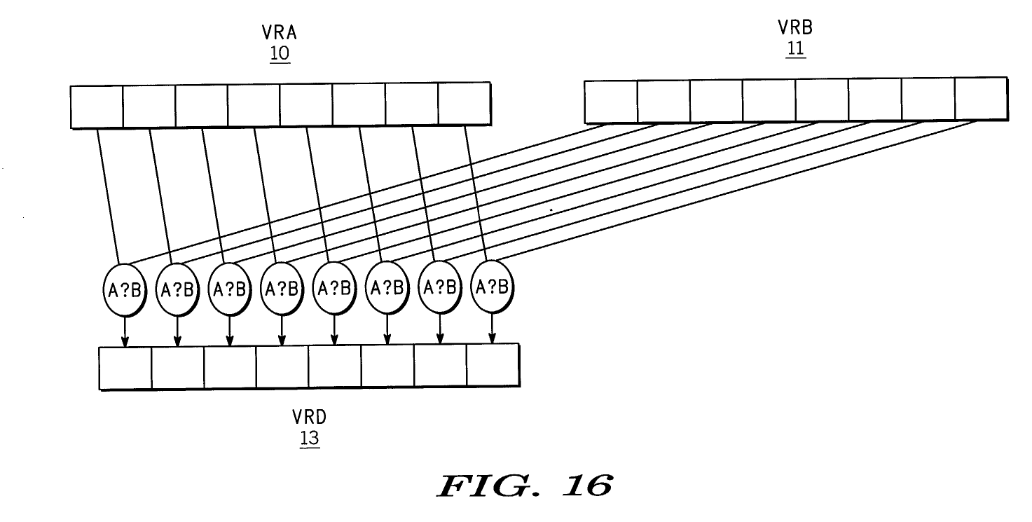

FIG. 16 illustrates an operational diagram of a Vector Compare instruction of the present invention that stores the field-wise comparison result of registers VRA 10 and VRB 11 (=‘00 . . . ’ if condition code is false, =‘11 . . . ’ if condition code is true) into the corresponding fields of register VRD 13. This instruction may be useful for data searches and tests. The notation “A ? B”, where “?” represents different types of comparison operators including examples such as greater than, greater than or equal, less than, less than or equal, equal, and not equal.

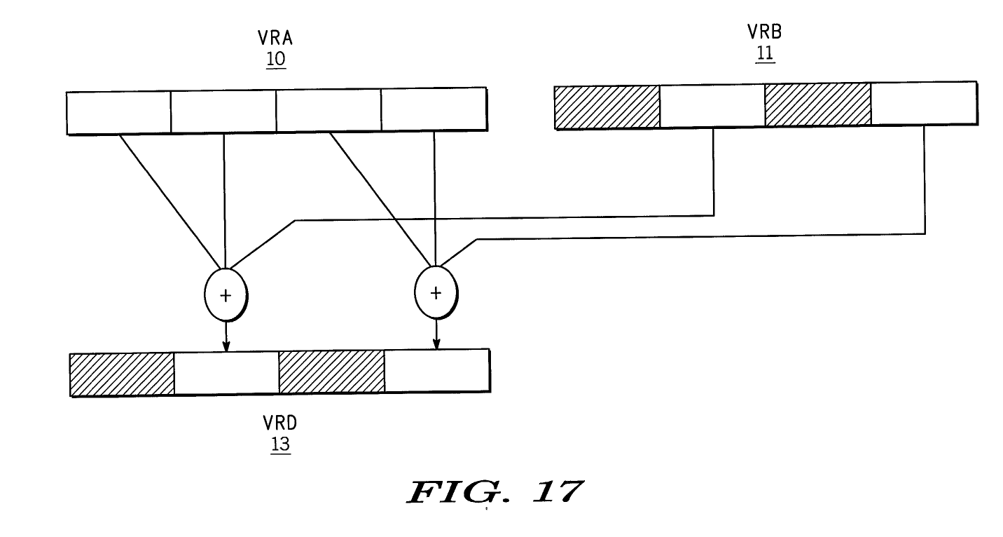

FIG. 17 illustrates an operational diagram of a Vector Final Multipoint Sum compound instruction (“vfsum”) of the present invention that sums two groups of two adjacent 32-bit fields in register VRA 10 (fields 2j and 2j+1 are added together where j=0 and 1), adds them to the two 32-bit accumulators in register VRB 11 (the odd-numbered fields), and stores the two 32-bit results in register VRD 13 (in the odd-numbered fields). This compound instruction may be useful for multipoint algorithms (where two separate outputs are computed simultaneously) or for simultaneously computing real and imaginary results.

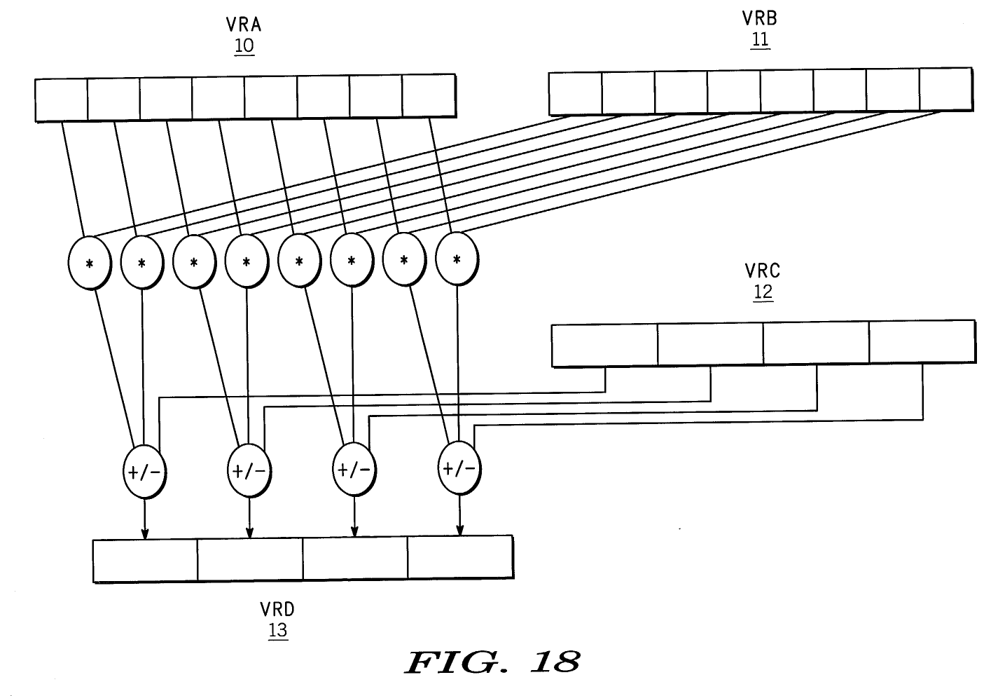

FIG. 18 illustrates an operational diagram of a Vector Multiply-Add/Sub compound instruction (“vmac”/“vmacn”) of the present invention that may be useful for maximum throughput dot product calculations (e.g.—convolution, correlation, etc.). This compound instruction performs the maximum number of integer multiplies (16 8×8-bit or 8 16×16-bit). Adjacent (interfield) products of register VRA 10 and register VRB 11 (in groups of four neighboring 16-bit products or two neighboring 32-bit products) are added to or subtracted from the four 32-bit accumulator fields in register VRC 12, and the result is stored in register VRD 13.

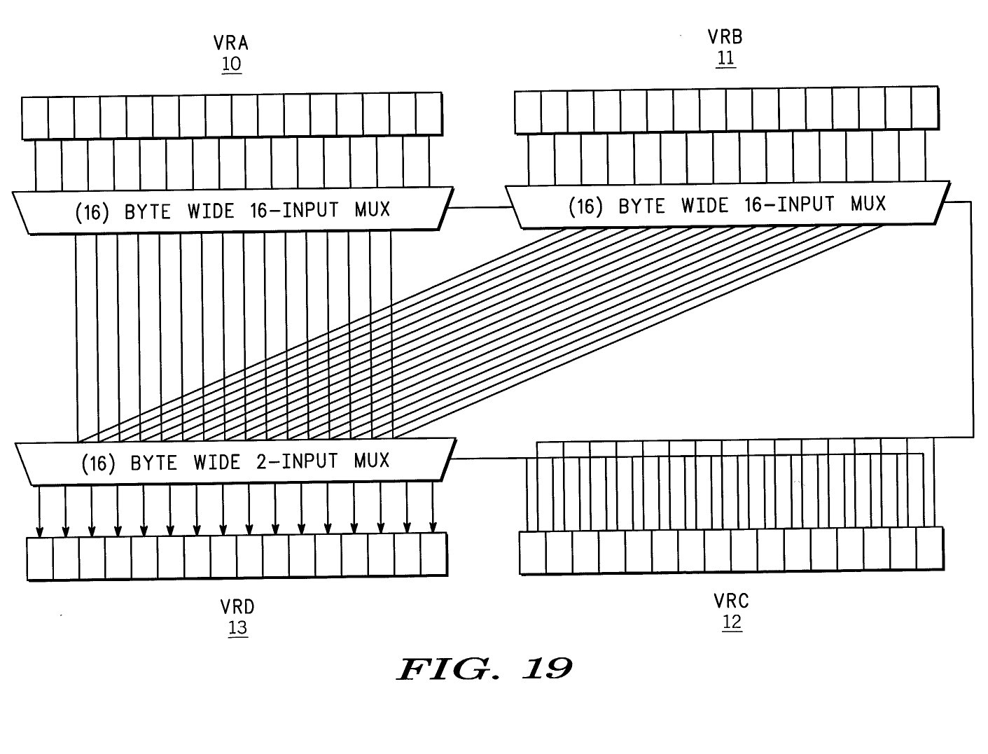

A detailed description of vector network unit instructions in accordance with the present invention are illustrated in FIGS. 19-32. In this embodiment, the grouping of instructions into units such as the vector network unit and vector arithmetic unit is selected to both maximize throughput and minimize power consumption. There may be other groupings to satisfy considerations, such as size and speed.

FIG. 19 illustrates an operational diagram of a Vector Permute instruction of the present invention that is any type of arbitrary reordering/shuffling of data elements or fields within a vector. The instruction is also useful for parallel look-up table (e.g., 16 simultaneous lookups from a 32 element×8-bit table) operations. This powerful instruction uses the contents of a control vector VRC 12 to select bytes from two source registers VRA 10 and VRB 11 to produce a reordering/combination of bytes in the destination register VRD 13. The control vector, which comprises m/8 control bytes, specifies the source byte for each byte in the destination register (0n⇄byte n₁₀ of VRA 110, 1n₂⇄byte n₁₀ of VRB 111, for n₁₀=0, . . . , 15 in a 128-bit register where n₂ represents a number written in binary format while n₁₀ is a number in decimal format). In this embodiment, because there are 16 bytes in the register and 2 source registers, 5 bits of the control byte are needed for specifying a source byte; these 5 bits can occupy the LSBs of the control byte while the 3 MSBs of each control byte can be ignored.

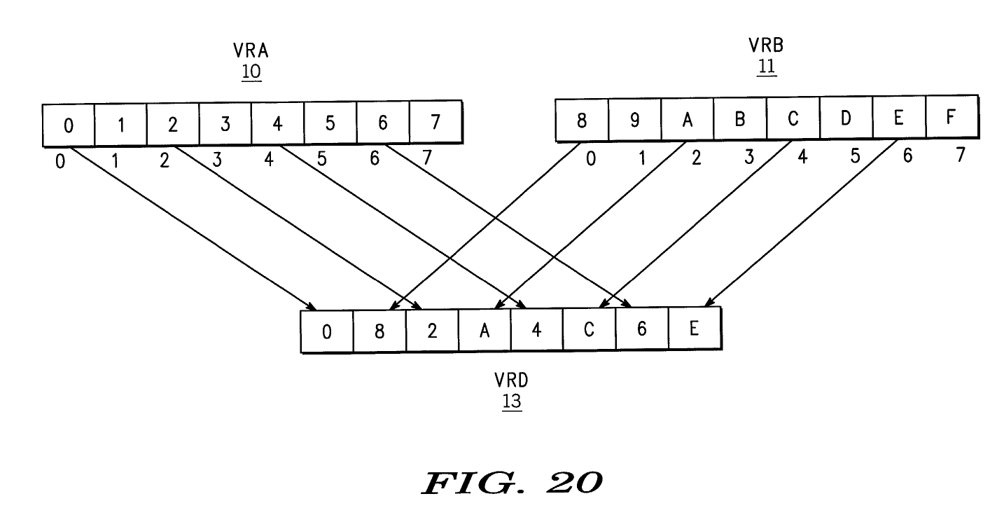

FIG. 20 illustrates an operational diagram of a Vector Merge instruction of the present invention that is useful for data ordering in fast transforms (FHT/FFT/etc.) This instruction combines (interleaves) two source vectors into a single vector in a predetermined way, by placing the upper/lower or even/odd-numbered elements (fields) of the source vectors (registers) into the even- and odd-numbered fields of the destination register VRD 13. The specified fields from the first source register VRA 10 are placed into the even-numbered elements of the destination register, while the specified fields from the second source register VRB 11 are placed into the odd-numbered elements of the destination register. This instruction may be emulated (or aliased) with the vector permute instruction. For illustration purposes, the vector merge operation is shown using the routing of the hexadecimal numbers within VRA 10 and VRB 11 to VRD 13.

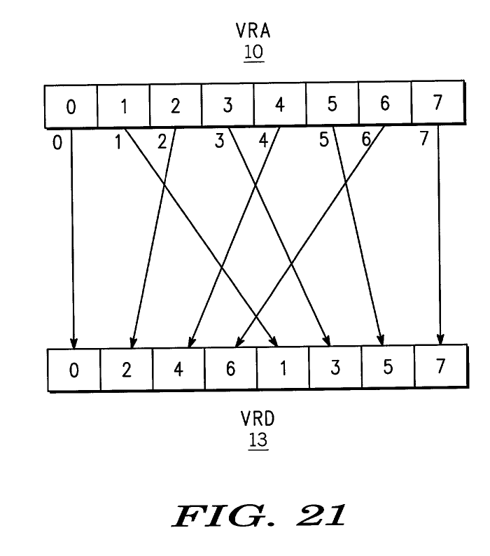

FIG. 21 illustrates an operational diagram of a Vector Deal instruction of the present invention. This instruction places the even-numbered fields of source register VRA 10 into the upper half (fields 0 to NF/2-1) of the destination register VRD 13, and places the odd-numbered fields of source register VRA 10 into the lower half (fields NF/2 to NF-1) of the destination register VRD 13. Note that only a single source register is utilized. This instruction may be emulated with the vector permute instruction.

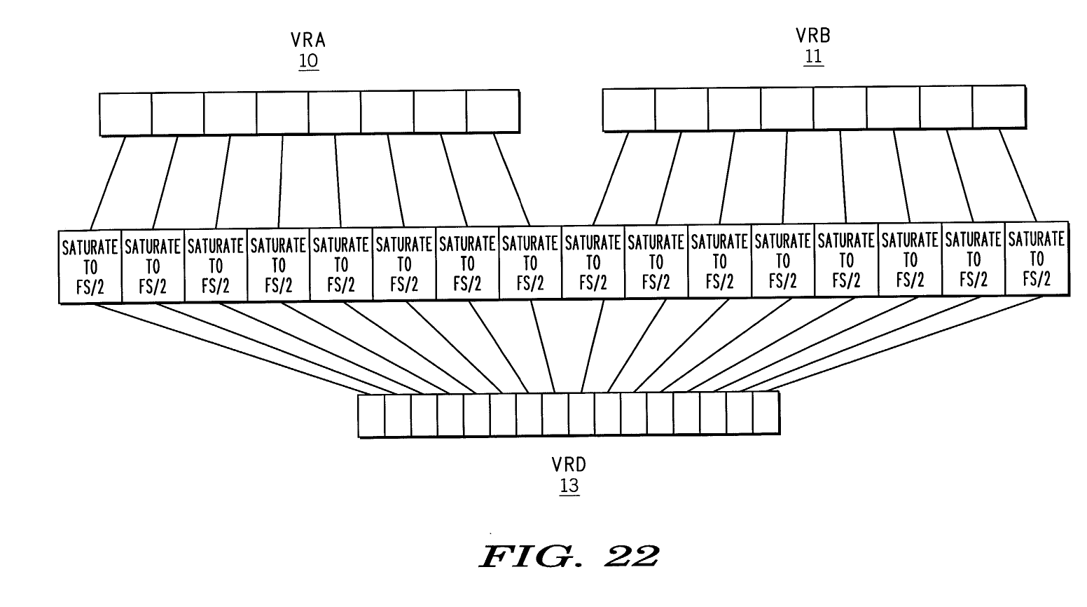

FIG. 22 illustrates an operational diagram of a Vector Pack instruction (“vpak”) of the present invention that can reduce sample precision of a field (packed version of a vector round arithmetic instruction). This instruction packs (or compresses) two source registers VRA 10 and VRB 11 into a single destination register VRD 13 (using the next smaller field size with saturation, i.e., a field of size FS is compressed into a field of size FS/2). Saturation of the least significant half of the source fields may be performed, or rounding (and saturation) of the most significant half of the source fields may be performed. Rounding mode is useful for arithmetically correct packing of samples to the next smaller field size (and reduces quantization error).

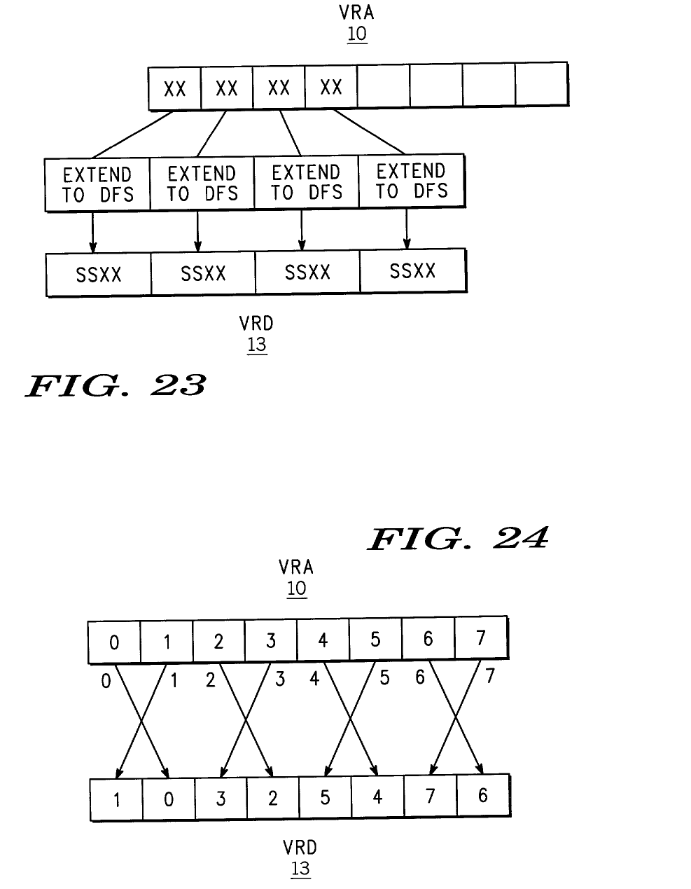

FIG. 23 illustrates an operational diagram of a Vector Unpack instruction of the present invention that is useful for the preparation of lower precision samples for full precision algorithms. This instruction unpacks (or expands) the high or low half of a source register VRA 10 into the next larger field size (i.e., a field of size FS is unpacked into a field of size DFS), using either sign extension (for signed numbers), or zero-filling (for unsigned numbers). The results can be either right justified or left justified in the destination fields of VRD 13. When either signed or unsigned inputs are left justified, the least significant portion of the destination fields of VRD 13 is zero-padded—(this feature is useful for preparing lower precision operands for higher precision arithmetic operations).

FIG. 24 illustrates an operational diagram of a Vector Swap instruction of the present invention. This instruction interchanges the position of adjacent pairs of data (fields) in the source register VRA 10 and stores the result in register VRD 13. This instruction may be emulated with the vector permute instruction.

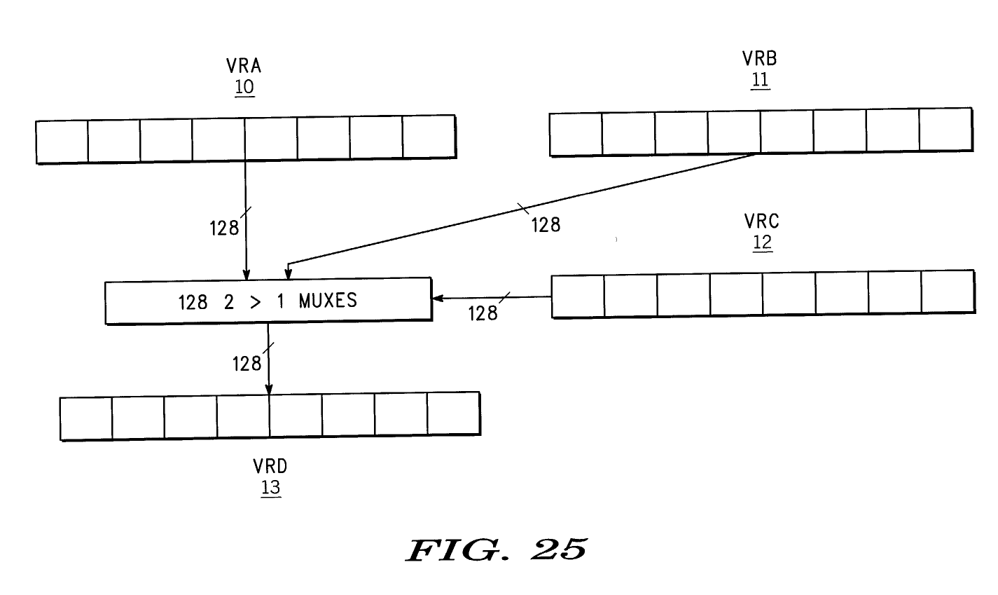

FIG. 25 illustrates an operational diagram of a Vector Multiplex instruction of the present invention that is useful for the general selection of fields or bits. This instruction selects bits or fields from either register VRA 10 (VRC 12 when the value of the corresponding control=0) or register VRB 11 (VRC 12 when the value of the corresponding control=1), and stores the result in register VRD 13. The control may be derived from VRC 12 on a bit by bit basis, on a field by field basis depending on the LSB of each control field, or on a field by field basis depending on the packed NF LSBs of the control vector. This operation can be used in conjunction with the vector compare instruction to select the desired fields from two vectors. The vector multiplex instruction is also useful (in packed mode) in conjunction with ‘vcnadd’ instruction for reduced operation count despreading.

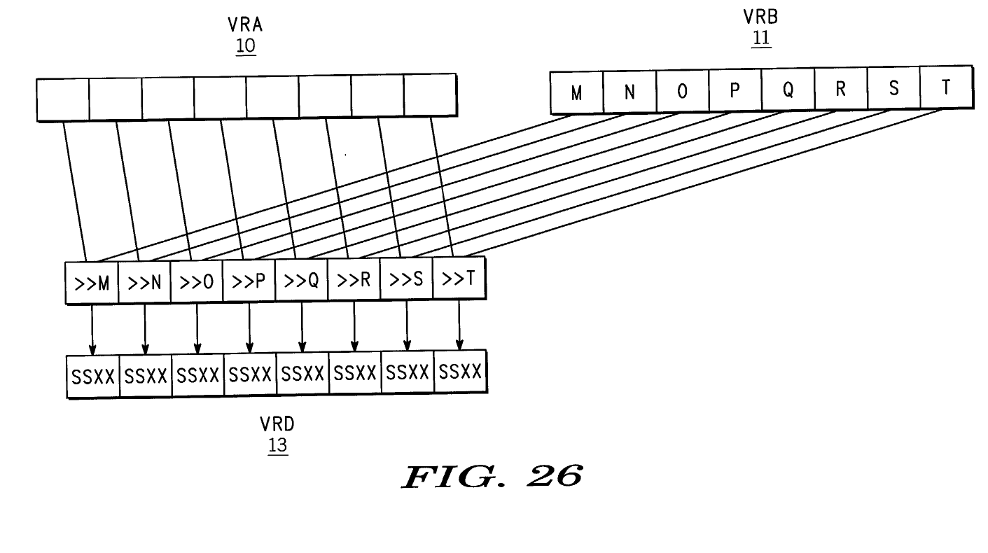

FIG. 26 illustrates an operational diagram of a Vector Shift Right/Shift Left instruction of the present invention that is useful for multipoint shift algorithms (normalization, etc.). This intrafield instruction shifts (logical or arithmetic) each field in register VRA 10 by the amount specified in the corresponding fields of register VRB 11. The shift amounts do not have to be the same for each field, and are specified by the LSBs in each field of register VRB 11. Note that negative shift values specify a shift in the opposite direction. The letters “M” through “T” in VRB 11 represent shift amounts. There may be saturation, zero-filling, sign extension, or zero-padding of results as denoted by “SSXX”.

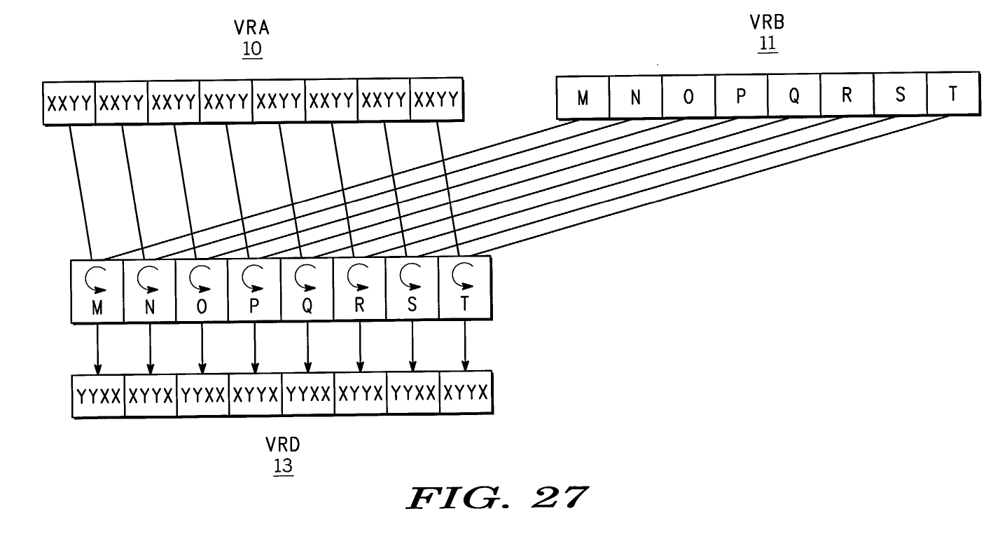

FIG. 27 illustrates an operational diagram of a Vector Rotate Left instruction of the present invention that is useful for multipoint barrel shift algorithms. This intrafield instruction rotates each field in register VRA 10 left by the amount specified in the corresponding fields of register VRB 11. The rotation (barrel shift) amounts do not have to be the same for each field, and are specified by the LSBs in each field of register VRB 11. Negative shift values produce right rotations (translation handled by hardware). The letters “M” through “T” in VRB 11 represent rotate amounts.

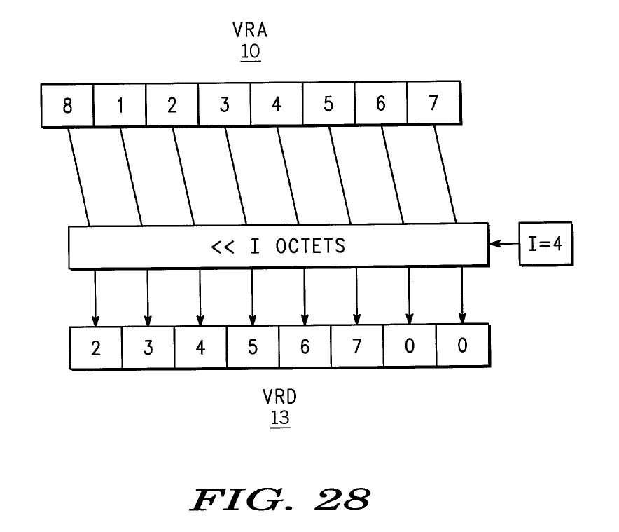

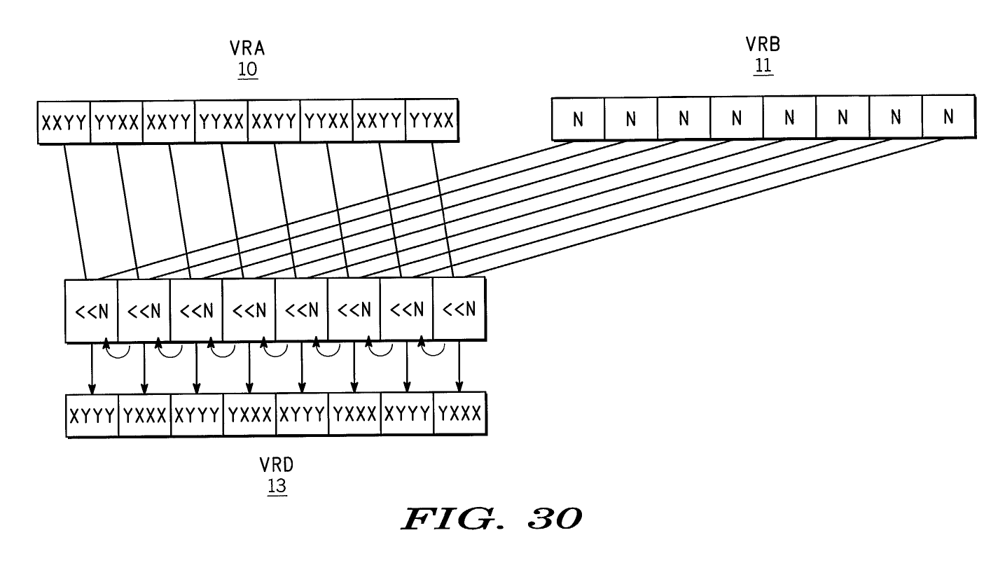

FIG. 28 illustrates an operational diagram of a Vector Shift Right By Octet/Shift Left By Octet instruction (“vsro”/“vslo”) of the present invention that is useful for arbitrary m-bit shifts. This instruction shifts the contents of register VRA 10 (logical right or left) by the number of bytes (octets) specified in a register or by an immediate value as illustrated with the 1=4 term in the figure. Note that only the log₂(m/q) LSBs (the ‘q=8’ term is due to the number of bits in a byte/octet) are utilized for the shift value from the register or immediate value. This instruction can be used with the vector shift right/vector shift left by bit instructions, as shown in FIG. 30, to obtain any shift amount [0-(m-1)].

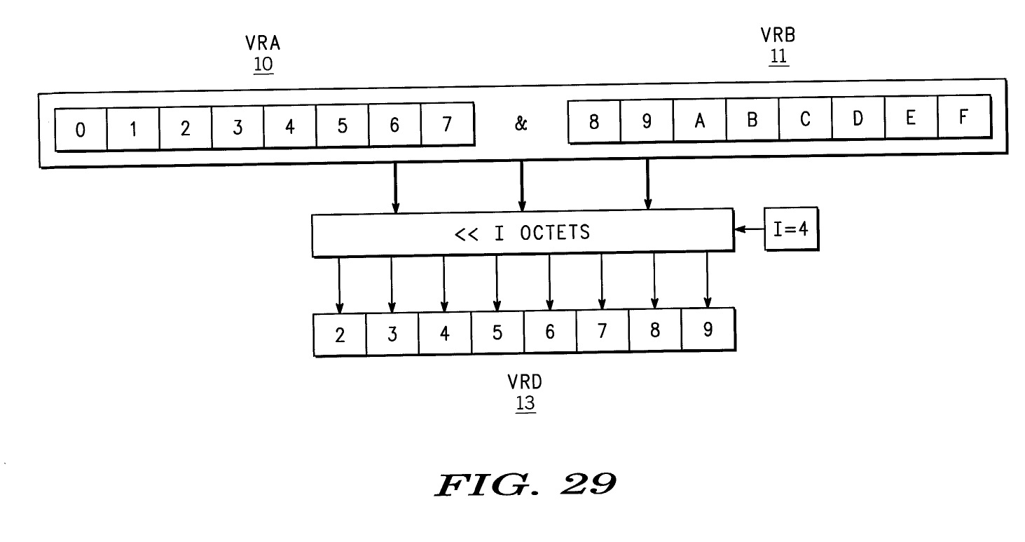

FIG. 29 illustrates an operational diagram of a Vector Concatenate Shift Right By Octet/Shift Left By Octet compound instruction of the present invention that can be used to shift data samples through a delay line (used in FIR filtering, IIR filtering, correlation, etc.). This instruction concatenates register VRA 10 and register VRB 11 (VRA 10&VRB 11 or VRB 11&VRA10) together and left or right shifts (logical, respectively) the result by the number of bytes (octets) specified by an immediate field or a register. Note that only the log₂(m/q) LSBs are utilized for the shift value from the register or immediate value. A zero shift value can place VRA 10 into the destination register VRD 13.

FIG. 30 illustrates an operational diagram of a Vector Shift Right/Shift Left By Bit instruction of the present invention that is useful for arbitrary m-bit shifts. This instruction performs an interfield shift of the contents of register VRA 10 (logical right or left) by the number of bits specified in register VRB 11 (only log₂(q) LSBs are evaluated). In this embodiment, all fields of VRB 11 must be equal. This instruction can be used with the vector shift right by octet/shift left by octet instructions described in FIG. 28 to obtain any shift amount [0-(m-1)].

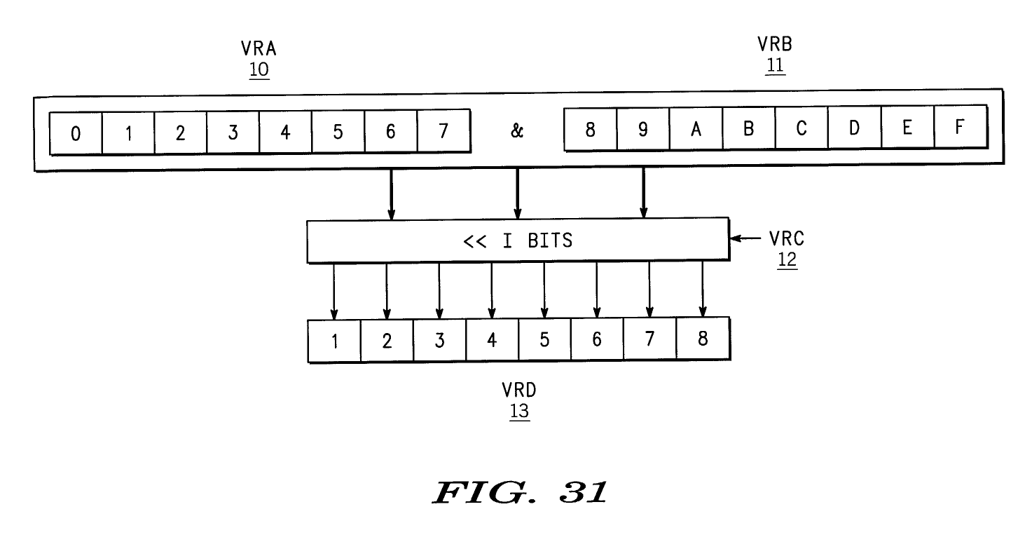

FIG. 31 illustrates an operational diagram of a Vector Concatenate Shift Right/Shift Left By Bit compound instruction of the present invention that is useful for implementing linear feedback shift registers (LFSRs) and other generators/dividers. This instruction concatenates register VRA 10 and register VRB 11 (VRA 10&VRB 11 or VRB 11&VRA 10) together and left or right shifts (logical, respectively) the result by the specified number of bits (specified by the q LSBs in each field of VRC 12 or another register). Alternatively, the shift value may be specified by an immediate value (for example, coded in the instruction itself). In this embodiment, a zero shift value places VRA 10 into the destination register VRD 13.

FIG. 32 illustrates an operational diagram of a Vector Select And Viterbi Shift Left compound instruction of the present invention that is useful for fast Viterbi equalizer/decoder algorithms (in conjunction with vector compare-maximum/minimum instructions)—employed in MLSE and DFSE sequence estimators. Also this instruction is useful in binary decision trees and symbol slicing. This instruction selects the surviving path history vector (VRA 10 or VRB 11) based on the conditional fields (LSBs) in VRC 12, shifts the surviving path history vector left by one bit position, appends the surviving path choice (‘0’ or ‘1’) to the surviving path history vector and stores the result in VRD 13. This operation can be software pipelined with the vector compare-maximum/minimum (VA) instructions.

There may other RISC-type instructions and functional units used in a SIMD processor. Using a similar methodology/procedure as used for the compound SIMD instructions described above, a different set of compound SIMD instructions are possible.

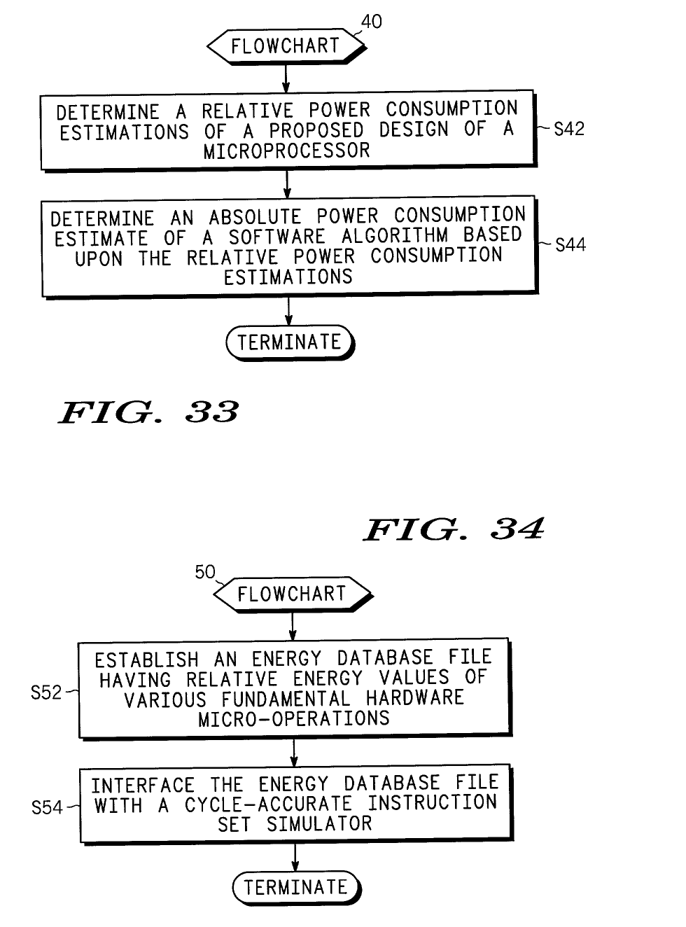

FIG. 33 illustrates a flowchart 40 representative of a power consumption estimation method in accordance with the present invention. During a stage S42 of the flowchart 40, relative power consumption estimates of a proposed design of a microprocessor (e.g., a SIMD processor) are determined. The relative power consumption estimates are used to model the operation of software on the proposed microprocessor. In one embodiment, the relative power consumption estimates are obtained by breaking down typical microprocessor operations to the micro-operation level (e.g., memory/register file reads/writes, add/subtract operations, multiply operations, logical MUX operations, etc.,) and associating a relative energy value (i.e., energy consumption value) to each micro-operation. The class of each micro-operation as well as a precision of each micro-operation (especially for parallel processors) determines its associated power consumption, since the operational complexity of the micro-operation is proportional to the number of logical transitions associated with the micro-operation, which is in turn proportional to the dominate term in overall CMOS logic power consumption. In addition, the relative power consumption estimates are also affected by instruction modes and even data (argument) information. Typically, random data vectors are utilized to characterize the energy consumption of each vector instruction in each particular operating mode. A completion of stage S42 results in a facilitation of timely simulations of the proposed microprocessor during a stage S44 of the flowchart 40 despite the fact that an entire processor design can not be effectively simulated at the circuit level. Stage S42 can be repeated numerous times to adjust a complexity and an accuracy of the relative power consumption estimates in view of an accumulation of information on the proposed microprocessor design and algorithm.

Stage S44 involves a determination of an absolute power consumption estimate for a software algorithm to be processed by the proposed microprocessor based upon the relative power consumption estimates. In one embodiment, the absolute power consumption estimate can be obtained on the basis of RTL-level power estimation tools (e.g., Sente) for the given micro-operations, or at the circuit level (e.g., Powermill, Spice, etc.). The absolute power consumption estimate can include, but is not limited to, machine state information, bus data transition information, and external environment effects. Since the micro-operations are relatively atomic (and unchanging once the processor is designed), overall power consumption can be effectively modeled on the basis of those operations. By allowing the system to operate in either general or specific terms, the needs of both rapid evaluation and accurate simulation can be addressed.

FIG. 34 illustrates a flowchart 50 representative of a relative power consumption method of the present invention that can be implemented during stage S42 of the flowchart 40 (FIG. 33). During a stage S52 of the flowchart 50, an energy database file listing various micro-operations and associated relative energies is established. Specifically, the methodology of instruction-level power estimation utilizes relative energy values of various fundamental hardware micro-operations such as register file read/write accesses, data memory read/write accesses, multiplication, addition, subtraction, comparison, shifting and multiplexing operations to thereby facilitate an estimation of the overall energy consumption of code routines. Each micro-operation has its own power characteristics based on the complexity of the logic circuits involved and the required precision. The following TABLE 1 is an exemplary listing of micro-operations and associated relative energy:

TABLE I

| Micro-operation | Relative Energy (E) |
|---|---|
| 16-bit add/subtract | 2.5 |
| 16-bit multiply | 20 |
| 16-bit register file read | 20 |
| 16-bit register file write | 30 |
| 16-bit 2-to-1 mux | 1.25 |
| 16-bit barrel shift | 8.125 |
| 16-bit data memory read | 122.5 |
| 16-bit data memory write | 183.75 |

During a stage S54 of flowchart 50, the energy database may interface with a conventional cycle-accurate ISS that allows developers to run their code in an environment more conducive to development. Often times monitoring performance on operational systems can be a challenge. This interface facilitates an opportunity for developers to tune their software even before silicon is available to provide the most power efficient algorithm designs, as well as improving throughput.

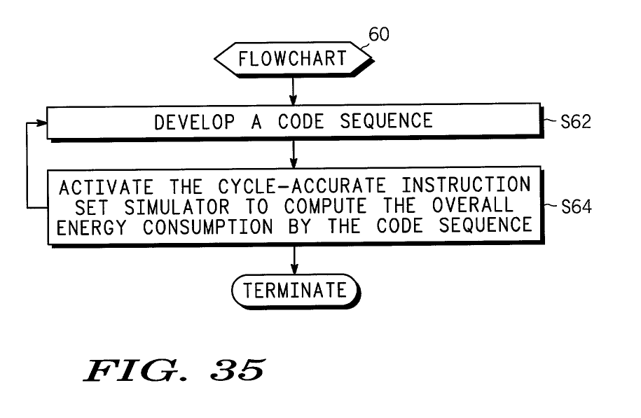

FIG. 35 illustrates a flowchart 60 representative of an absolute power consumption method of the present invention that can be implemented during stage S44 of the flowchart 40 (FIG. 33). During a stage S62 of the flowchart 60, a code sequence is developed. The code sequence includes a plurality of instructions with each instruction composed of a combination of micro-operations. A code sequence may also be a software algorithm. Thus, the relative energy value of each instruction is equal to the sum of the energy values for the corresponding micro-operations. In one embodiment, the code sequence includes compound instructions or operations that combine more typical sets of computations into a single instruction, because compound instructions and combination operations are more efficient in accessing the data operands and require less decoding to complete (i.e.—they contain fewer micro-operations than their traditional counter-parts). Consequently, the relative energy values of the compound instructions and the combination operations will be less than the relative energy values of traditional operations. Compound instructions and combination operations therefore consume less power than traditional operations.

During a stage S64 of the flowchart 60, the cycle-accurate ISS is activated to compute the overall energy consumption by the code sequence. In one embodiment, the ISS generates a metric for each instruction in a given microprocessor/co-processor architecture (based on the micro-operations it contains) and stored in a database. The cycle-accurate instruction set simulator can then read in this energy database file and calculate the overall energy consumption based on the instruction profile of the algorithm under development. The total energy consumption of an algorithm or routine can be recorded and displayed by the instruction set simulator, allowing the designer to evaluate the effects of different instruction mixes or uses in a code routine on overall energy consumption. Thus tradeoffs between energy consumption and performance can be immediately observed and compared by the code developer. For example, a 128-bit vector add-and-subtract instruction (i.e., eight parallel 16-bit) includes two 128-bit register file read accesses, one 128-bit addition operation, one 128-bit subtraction operation, and two 128-bit register file write accesses. From TABLE 1, the relative energy consumption of 128-bit vector add-and-subtract instruction is thus equal to (2×160)+(2×20)+(2×240)=840 E. Other effects, such as program memory fetches and instruction decodes may also be incorporated in the figure.

The following TABLE 2 illustrates an exemplary code sequence of a 64 point complex despreading operation in accordance with the prior art: The function unit column in TABLE 2 indicates the part of the microprocessor architecture that performs the operation. In this embodiment, there are two load/store units labeled LSA and LSB. Each load/store unit can read/write at vector from/to memory. The load/store unit in this example comprises pointer registers labeled C1, A0, A1, A2, and A16. The register file uses complex-domain registers (data vectors) that are labeled R1, R2, R3, R4, R16, R17, RA, and RB. The real (in-phase “I”) component of Rx is labeled Rx.r, the imaginary (quadrature “Q”) component of Rx is labeled Rx.i, and the real and imaginary pair in Rx is labeled Rx.c, where x represents any of the registers listed above.

The instruction set mnemonics are fairly self-explanatory. The notation “xxxdd” implies a “xxx” operation using “dd”-bit fields/registers. For instance LDVR128 is a 128-bit load operation while VMPY8 is a SIMD vector multiplication instruction using 8-bit fields. A typical instruction notation is “INSTRUCTION destination register D, source register A, source register B, . . . ”. The partitioning of instructions into very large instruction word (VLIW) functional units allows for parallel operations during an instruction cycle, thereby increasing throughput. For example, in the third line, the microprocessor performs two SIMD multiplications and one load.

TABLE 2

| Line/ | function | | |
|---|---|---|---|
| cycles | units | instruction | comments |
| 1 | LSA/LSB | LDVR128 R1.c, A0++ | ; load complex PN sequence (16 bits of I & Q |
| | | | codes) from memory into R1 using pointer in A0. |
| | | | Appropriately post increment the pointer value |
| 2 | LSA/LSB | LDVR128 R2.c, A1++ | ; load 16 decimated input samples from memory |
| | | | into R2 using pointer in A1. Appropriately post |
| | | | increment the pointer value |
| 3 | VAA | VMPY8 RA.r, RB.r, R1.r, R2.r | ; calculate (I*I) real components from R1.r and |
| | VAB | VMPY8 RA.i, RB.i, R1.i, R2.r | R2.r. Store product in RA.r. |
| | LSA/LSB | LOOPENi C1, 7, DESPREAD, END | ; calculate (Q*I) imag components from R1.i and |
| | | | R2.r. Store product in RA.i. |
| | | | ; declare a loop of 7 iterations bounded by labels |
| | | | DESPREAD and END. |
| 4 | | DESPREAD | ; calculate (Q*Q) real components from R1.i and |
| | VAA | VMACN8 RA.r, RB.r, R1.i, R2.i | R2.i. Subtract product from value in RA.r |
| | VAB | VMAC8 RA.i, RB.i, R1.r, R2.i | ; calculate (I*Q) imag components and |
| | LSA/LSB | LDVR128 R1.c, AO ++ | accumulate |
| | | | load next 16 I & Q PN sequence bits |
| 5 | LSA/LSB | LDVR128 R2.c, A1 ++ | ; load next 16 I & Q sampled chips |
| 6 | VAA | VMAC8 RA.r, RB.r, R1.r, R2.r | ; calculate next (I*I) real components and |
| | VAB | VMAC8 RA.i, RB.i, R1.i, R2.r | accumulate |
| | | | calculate next (Q*I) imag components and |
| | | | accumulate |
| | | | perform 1^{ST} stage of accumulation |
| | | | (combine 4-8b into 32b fields) |
| 7 | | END | ; calculate final-(Q*Q) component accumulation |
| | VAA | VMAC8 R16.r, R17.r, R1.i, R2.i | ; calculate final (I*Q) component accumulation |
| | VAB | VMAC8 R16.i, R17.i, R1.r, R2.i | |
| 8 | VNA/VNB | VPAK16 R3.c, R16.c, R17.c | ; pack intermediate results |
| 9 | VAA/VAB | VPSUM48 R3.c, R3.c, R0.c | ; perform 1st stage of accumulation |
| | | | (combine 4-8b into 32b fields) |
| 10 | VAAIVAB | VFSUM32 R3.c, R3.c, R0.c | ; perform final stage of integration |
| | | | (single 32b result) |
| 11 | LSA/LSB | STVR128 A2 ++, R4.c | ; store complex despreader output (representing |
| | | | complex symbol) |

First, the PN sequence and input samples are loaded from data memory to register files. Complex multiplication between the PN sequence and input vector is executed via vector multiply (‘vmpy’) and vector multiply-accumulate (‘vmac’) instructions. Intermediate results are stored in accumulator registers (‘RA’ and ‘RB’) and the accumulated vector elements are summed together via vector partial sum (‘vpsum’) and vector final sum (‘vfsum’) instructions. The code sequence of TABLE 2 requires 29 cycles to execute and consumes 82,748E units of energy. These relative energy units can be mapped to an absolute power consumption estimate through the use of an appropriate scaling factor (e.g., obtained through measurement). Note that the ISS models the complete action of the software algorithm. That is, the ISS keeps a running total of all of the executed instructions and their subsequent micro-operations and energy levels (including those executed in any of several loop passes).

By comparison, the following TABLE 3 illustrates an exemplary code sequence of a 64 point complex despreading operation in accordance with the present invention:

TABLE 3

| Line/ | function | | |
|---|---|---|---|
| cycles | units | instruction | comments |
| 1 | LSA/LSB | LDVR128 R16.c, A0++ | ; load packed complex PN sequence (128 bits of I |
| | | | & Q codes) |
| 2 | VNA/VNB | VORR1.c, R16.c, R16.c | ; make PN sequence available to VA units |
| | LSAILSB | LDVR128 R2.c, A1++ | ; load 16 decimated input samples |
| | VAA/VAB | VSUR8 R3.c, R3.c, R3.c | ; clear initial accumulator value |
| | BCU | SCSUB A16, A16, A16 | ; set a16 = 0 (shift index) |
| 3 | LSA/LSB | LOOPENi C1, 8, DESPREAD, END | ; loop declaration |
| 4 | VAA | DESPREAD | |
| | VAB | VCNADD8 R3.r, R2.r, R1.r, R3.r | ; calculate 16 (I*I) portions and add w/0 |
| | BCU | VCNADD8 R3.i, RZ.i, R1.r, R3.i | ; calculate 16 (Q*I) portions and add w/0 |
| | | SCADDi A16, A16, 2 | ; increment shift index for next 16 samples |
| 5 | VAA | VCNSUB8 R3.r, R2.i, R1.1, R3.r | ; calculate (Q*Q) portions and accumulate |
| | VAB | VCNADD8 R3.i, R2.r, R1.i, R3.i | ; calculate (I*Q) portions and accumulate |
| | VNA/VNB | VSROa R1.c, R16.c, A16 | ; shift PN sequence by additional 16-bits |
| | LSA/LSB | LDVR128 R2.c, A1++ | ; load next 16 I & Q sampled chips |
| | | | done with multipoint integration |
| 6 | | END | ; perfomi 1^{st} tage of accumulation |
| | VAA/VAB | VSUM48 R3.c, R3.c, R0.c | (COMBINE 4-8B INTO 32B FIELDS) |
| 7 | VAA/VAB | VSUM32 R3.c, R3.c, R0.c | ; perform final stage of integration |
| | | | (single 32b result) |
| 8 | LSA/LSB | STVR128 A2, R3.c | ; store complex despreader output (representing |
| | | | complex symbol) |

The PN sequence is stored in a packed format in data memory. Also, the vector conditional negate and add (‘vcnadd’) compound instruction is used to improve algorithm performance and reduce energy consumption in this example. The code sequence (using the compound instructions) of TABLE 3 requires 22 cycles to execute and consumes 62,626E units of energy (using relative energy estimation in the ISS based on the combined micro-operations). This level of power savings can be quite significant in portable products. TABLE 3 shows that the improved code sequence achieves a processing speedup and simultaneously improves power performance compared to the original code sequence. This ability to quickly evaluate different forms of software code subroutines becomes critical as algorithm complexity increases. Note that a software algorithm may be an entire piece of software code, or only a portion of a complete software code (e.g., as in a subroutine).

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. A method of forming a compound Single Instruction/Multiple Data instruction, said method comprising:
selecting at least two Single Instruction/Multiple Data operations of a reduced instruction set computing type; and
combining said at least two Single Instruction/Multiple Data operations to execute in a single instruction cycle to thereby yield the compound Single Instruction/Multiple Data instruction.

2. The method of claim 1, further comprising:
evaluating a processing throughput of the compound Single Instruction/Multiple Data instruction; and
determining a power consumption of the compound Single Instruction/Multiple Data instruction.

3. The method of claim 2, further comprising:
associating an energy consumption value with at least one micro-operation of the compound Single Instruction/Multiple Data instruction; and
minimizing the sum of the energy consumption value.

4. The method of claim 1, wherein the compound Single Instruction/Multiple Data instruction includes a vector add-subtract operation.

5. The method of claim 1, wherein the compound Single Instruction/Multiple Data instruction includes a vector minimum-difference operation.

6. The method of claim 1, wherein the compound Single Instruction/Multiple Data instruction includes a vector compare-maximum operation.

7. The method of claim 1, wherein the compound Single Instruction/Multiple Data instruction includes a vector absolute difference and add operation.

8. The method of claim 1, wherein the compound Single Instruction/Multiple Data instruction includes a vector average operation.

9. The method of claim 1, wherein the compound Single Instruction/Multiple Data instruction includes a vector scale operation.

10. The method of claim 1, wherein the compound Single Instruction/Multiple Data instruction includes conditional operations on elements of a data vector.

11. The method of claim 10, wherein the compound Single Instruction/Multiple Data instruction includes a vector conditional negate and add operation.

12. The method of claim 10, wherein the compound Single Instruction/Multiple Data instruction includes a vector select and viterbi shift left operation.

13. A method of estimating a relative power consumption of a software algorithm, comprising:
establishing a relative energy database listing a plurality of micro-operations, each micro-operation having an associated relative energy value; and
determining the relative power consumption of the software algorithm incorporating one or more of the micro-operations based on the relative energy values of the incorporated micro-operations.

14. The method of claim 13, further comprising:
executing the software algorithm on a simulator; and
computing a sum of the relative energy values of the micro-operations contained in the executed software algorithm.

15. The method of claim 13, wherein:
at least one of the micro-operations of the software algorithm is executed on a Single Instruction/Multiple Data processing unit.

16. A method for estimating the absolute power consumption of a software algorithm, comprising:
determining a plurality of relative power estimates of instructions of a microprocessor;
simulating a software algorithm including one or more compound instructions; and
determining an absolute power estimate of a software algorithm to be executed by the microprocessor based on the relative power estimates.
